(19) United States
(12) Patent Application Publication
(10) Pub. No.: US 2023/0411695 A1
(43) Pub. Date: Dec. 21, 2023

(54) ELECTROCHEMICAL CELLS WITH HIGH-VISCOSITY SEMI-SOLID ELECTRODES, AND METHODS OF MAKING THE SAME

(71) Applicant: 24M Technologies, Inc., Cambridge, MA (US)

(72) Inventors: Kai NARITA, Boston, MA (US); Yuki KUSACHI, Burlington, MA (US); Naoki OTA, Lexington, MA (US); Junzheng CHEN, Concord, MA (US)

(21) Appl. No.: 18/212,414

(22) Filed: Jun. 21, 2023

Related U.S. Application Data
(60) Provisional application No. 63/354,056, filed on Jun. 21, 2022.

(51) Int. Cl. H01M 10/0568; H01M 50/431; H01M 4/04; H01M 10/0569; H01M 4/66

(52) U.S. Cl. CPC H01M 10/0568; H01M 50/431; H01M 4/0438; H01M 10/0569; H01M 4/663; H01M 2004/023

(57) ABSTRACT

Embodiments described herein relate to electrode and electrochemical cell material recycling. Recycling electrode materials can save significant costs, both for quenching chemicals and for the costs of the materials themselves. Separation processes described herein include centrifuge separation, settler separation, flocculant separation, froth flotation, hydro cyclone, vibratory screening, air classification, and magnetic separation. In some embodiments, methods described herein can include any combination of froth flotation, air classification, and magnetic separation. In some embodiments, electrolyte can be separated from active and/or conductive materials via drying, subcritical or supercritical carbon dioxide extraction, solvent mass extraction (e.g., with non-aqueous or aqueous solvents), and/or freeze-drying. By applying these separation processes, high purity raw products can be isolated. These products can be re-used or sold to a third party. Processes described herein are scalable to large cell production facilities.

### CROSS REFERENCE TO RELATED APPLICATIONS

This application claims priority to U.S. Provisional Patent Application No. 63/354,056 filed Jun. 21, 2022 and titled “Electrochemical Cells with High-Viscosity Semi-Solid Electrodes, and Methods of Making the Same,” the disclosure of which is hereby incorporated by reference in its entirety.

### TECHNICAL FIELD

Embodiments described herein relate to high-viscosity semi-solid electrodes, and methods of making the same.

### BACKGROUND

In the production of electrochemical cells, electrodes can be coated onto current collectors and electrolyte can be added thereafter. The coating of the current collectors and the electrolyte addition are often separate steps. This manufacturing process can limit the feasible thickness of an electrode and the selection of electrolytes. Semi-solid electrodes can be manufactured with active materials, conductive materials, and electrolytes. The active materials, conductive materials, and electrolytes can be casted together as a semi-solid electrode. Semi-solid electrodes can be made binderless, such that movement of electroactive species is less limited. However, thick semi-solid electrodes are often inhibited by ion transport limitations. Lithium ion depletion during charge or discharge can be a problem, particularly during fast charge and fast discharge. Improvement of ion transport can mitigate these issues.

### SUMMARY

Embodiments described herein relate to methods of producing semi-solid electrodes. In some aspects, a method can include combining an active material with a conductive material and a non-aqueous liquid electrolyte to form a semi-solid cathode, the non-aqueous liquid electrolyte having a salt concentration of at least about 2,000 mol/m³, disposing the semi-solid cathode onto a cathode current collector, the semi-solid cathode having a thickness of at least about 150 μm, disposing an anode onto an anode current collector, wetting a first surface of the separator with the non-aqueous liquid electrolyte, coating the first surface of the separator with a carbon coating, and disposing the anode onto the cathode with the separator interposed therebetween to form an electrochemical cell, such that the first surface of the separator contacts the semi-solid cathode. In some embodiments, the method can further include charging and discharging the electrochemical cell while the electrochemical cell is oriented such that the thickness of the cathode is in line with the direction of gravity. In some embodiments, the non-aqueous liquid electrolyte can have a salt concentration of at least about 3,000 mol/m³. In some embodiments, the carbon coating can include hard carbon. In some embodiments, the discharging are at a rate of at least about 1.5 C.

### BRIEF DESCRIPTION OF THE DRAWINGS

FIG. 1 is a block diagram of a method for producing a high-viscosity semi-solid electrode, according to an embodiment.

FIG. 2 is a block diagram of an electrochemical cell with a high-viscosity semi-solid electrode, according to an embodiment.

FIG. 3 is an illustration of an electrochemical cell with a high-viscosity semi-solid electrode, according to an embodiment.

FIGS. 4A-4B show simulated electric potentials and electrolyte salt concentrations of a high-viscosity semi-solid electrode, according to an embodiment.

FIG. 5 shows density of a semi-solid electrode as a function of electrolyte salt concentration.

FIG. 6 shows rate capability with different cell orientations.

FIG. 7 shows capacity retention and internal resistance of cells in different orientations.

FIG. 8 shows capacity retention of electrochemical cells with a high-viscosity semi-solid electrode.

FIG. 9 shows capacity retention of electrochemical cells with a high-viscosity semi-solid electrode.

### DETAILED DESCRIPTION

Embodiments described herein relate to high-viscosity semi-solid electrodes, and methods of making the same. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

The power of a thick electrode is often limited by ion transport. Lithium ion depletion during charge or discharge is a significant issue in cells, particularly during fast charge (e.g., at least 1 C) or fast discharge (e.g., at least 1 C). A high concentration of electrolyte salt can mitigate lithium ion depletion. However, long ion transport paths in thick electrodes can limit rate capabilities of electrochemical cells with thick, semi-solid electrodes. For rate capabilities, ion transport is traditionally considered to be governed by migration and diffusion. Migration is a transport of ions driven by a voltage gradient. Diffusion is a transport of ions and species driven by a concentration gradient.

In some cases, lithium ion transport and power output of cells with semi-solid electrodes can be facilitated by convection, or a bulk transport driven by a density gradient. Convection can be introduced into a thick semi-solid electrode using an electrolyte with a high salt concentration. A thick electrode with a highly concentrated electrolyte can produce a significant concentration gradient in the electrolyte throughout the electrochemical cell during charge or discharge. This allows the introduction of a significant density gradient and a resultant effective convective transport. Introducing an electrolyte with a high salt concentration can increase the viscosity of the semi-solid electrode as well as the electrolyte therein, as well as the ion transport within the semi-solid electrode.

However, wettability of semi-solid electrodes can be limited. In other words, the high-viscosity semi-solid electrodes can have problems making contact with separators and/or current collectors. Wetting the separators with electrolyte solution can facilitate this contact. Coating the separator and/or the current collector with a carbon-containing material can also facilitate contact and ion movement.

Cells with semi-solid electrodes and concentrated electrolytes have exhibited enhanced rate capabilities. Gravity and a density gradient can be used to induce convective bulk transport. The density of electrolyte can be caused by a temperature difference, the architecture of the electrode material, and/or electrolyte additives. The driving force to cause bulk transport is not limited to gravity. In some embodiments, the bulk transport can be caused by the application of magnetic fields, a temperature gradient, and/or centrifugal forces.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L) of the materials included for the electrochemical cell to operate such as, the electrodes, the separator, the electrolyte, and the current collectors. Specifically, the materials used for packaging the electrochemical cell are excluded from the calculation of volumetric energy density.

As used herein, the terms “high-capacity materials” or “high-capacity anode materials” refer to materials with irreversible capacities greater than 300 mAh/g that can be incorporated into an electrode in order to facilitate uptake of electroactive species. Examples include tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

As used herein, the term “composite high-capacity electrode layer” refers to an electrode layer with both a high-capacity material and a traditional anode material, e.g., a silicon-graphite layer.

As used herein, the term “solid high-capacity electrode layer” refers to an electrode layer with a single solid phase high-capacity material, e.g., sputtered silicon, tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

As used herein, “density gradient” refers to a spatial variation in density at different depths. In other words, the amount of matter per unit volume changes from a first location to a second location.

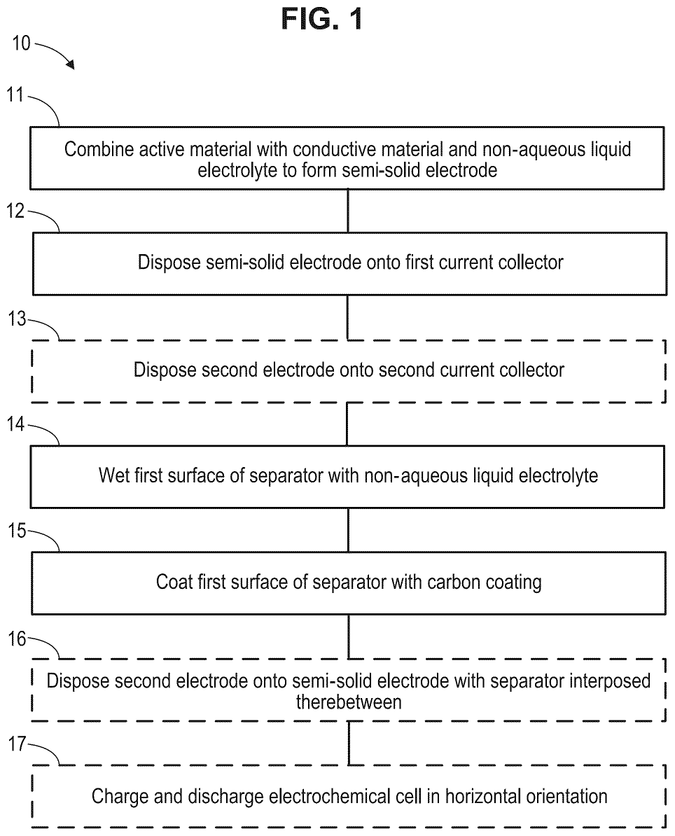

FIG. 1 is a block diagram of a method 10 for producing a high-viscosity semi-solid electrode, according to an embodiment. As shown, the method 10 includes combining an active material with a conductive material and a non-aqueous liquid electrolyte at step 11 to form a semi-solid electrode and disposing the semi-solid electrode onto a first current collector at step 12. The method 10 optionally includes disposing a second electrode onto a second current collector at step 13. The method 10 further includes wetting a first surface of a separator with a non-aqueous liquid electrolyte at step 14 and coating the first surface of the separator with a carbon coating at step 15. The method 10 optionally includes disposing the second electrode onto the semi-solid electrode with a separator interposed therebetween at step 16 and charging and discharging the electrochemical cell in a horizontal orientation at step 17.

Step 11 includes combining an active material with a conductive material and a non-aqueous liquid electrolyte to form a semi-solid electrode. In some embodiments, the semi-solid electrode can include a cathode. In some embodiments, the semi-solid electrode can include an anode. In some embodiments, the semi-solid electrode material can be crushed and/or grinded prior to mixing the semi-solid electrode material with the solvent. In some embodiments, the semi-solid electrode material can be crushed and/or grinded while mixing the semi-solid electrode material with the solvent. In some embodiments, the electrode slurry can be subject to grinding and/or crushing. In some embodiments, the semi-solid electrode material can be subjected to screening prior to mixing the semi-solid electrode material with the solvent. In some embodiments, the semi-solid electrode material can be subjected to screening while mixing the semi-solid electrode material with the solvent. The screening can separate larger particles from the semi-solid electrode. In some embodiments, the electrode slurry can be subject to screening. In some embodiments, the screening can include employing a vibratory screen.

In some embodiments, the semi-solid electrode can include an anode material. In some embodiments, the anode material can include a tin metal alloy such as, for example, a Sn—Co C, a Sn—Fe—C, a Sn—Mg—C, or a La—Ni—Sn alloy. In some embodiments, the anode material can include an amorphous oxide such as, for example, SnO or SiO amorphous oxide. In some embodiments, the anode material can include a glassy anode such as, for example, a Sn—Si Al—B—O, a Sn—Sb—S—O, a SnO₂—P₂O₅, or a SnO B₂—O₃—P₂O₅—Al₂O₃ anode. In some embodiments, the anode material can include a metal oxide such as, for example, a CoO, a SnO₂, or a V₂O₅. In some embodiments, the anode material can include a metal nitride such as, for example, Li₃N or Li₂·6CoO·4N. In some embodiments, the anode material can include an anode active material selected from lithium metal, carbon, lithium-intercalated carbon, lithium nitrides, lithium alloys and lithium alloy forming compounds of silicon, bismuth, boron, gallium, indium, zinc, tin, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon oxide, silicon carbide, any other high capacity materials or alloys thereof, and any other combination thereof. In some embodiments, the anode active material can include silicon and/or alloys thereof. In some embodiments, anode active material can include tin and/or alloys thereof.

In some embodiments, the semi-solid electrode can include a cathode material. In some embodiments, the cathode material can include the general family of ordered rocksalt compounds LiMO₂ including those having the α-NaFeO₂ (so-called “layered compounds”) or orthorhombic-LiMnO₂ structure type or their derivatives of different crystal symmetry, atomic ordering, or partial substitution for the metals or oxygen. M comprises at least one first-row transition metal but may include non-transition metals including but not limited to Al, Ca, Mg, or Zr. Examples of such compounds include LiFePO₄ (LFP), LiCoO₂, LiCoO₂ doped with Mg, LiNiO₂, Li(Ni, Co, Al)O₂ (known as “NCA”) and Li(Ni, Mn, Co)O₂ (known as “NMC”). In some embodiments, the cathode material can include a spinel structure, such as LiMnPO₄ and its derivatives, so-called “layered-spinel nanocomposites” in which the structure includes nanoscopic regions having ordered rocksalt and spinel ordering, olivines LiMPO₄ and their derivatives, in which M comprises one or more of Mn, Fe, Co, or Ni, partially fluorinated compounds such as LiVPO₄F, other “polyanion” compounds as described below, and vanadium oxides VₓO_{y} including V₂O₅ and V₆O₁₁. In some embodiments, the cathode material can include a transition metal polyanion compound. In some embodiments, the cathode material can include an alkali metal transition metal oxide or phosphate, and for example, the compound has a composition Aₓ(M′₁₋ₐM″ₐ)_{y}(XD₄)_{z}, Aₓ(M′₁₋ₐM″ₐ)_{y}(DXD₄)_{z}, or Aₓ(M′₁₋ₐM″ₐ)_{y}(X₂D₇)_{z}, and have values such that x, plus y(1−a) times a formal valence or valences of M′, plus y(a) times a formal valence or valence of M″, is equal to z times a formal valence of the XD₄, X₂D₇, or DXD₄ group; or a compound comprising a composition (A₁₋ₐM″ₐ)ₓM′_{y}(XD₄)_{z}, (A₁₋ₐM″ₐ)ₓ(M′_{y}(DXD₄)_{z}(A₁₋ₐM″ₐ)ₐM′_{y}(X₂D₇)_{z} and have values such that (1−a)x plus the quantity ax times the formal valence or valences of M″ plus y times the formal valence or valences of M′ is equal to z times the formal valence of the XD₄, X₂D₇ or DXD₄ group. In the compound, A is at least one of an alkali metal and hydrogen, M′ is a first-row transition metal, X is at least one of phosphorus, sulfur, arsenic, molybdenum, and tungsten, M″ any of a Group HA, IIIA, IVA, VA, VIA, VIIA, VIIIA, IB, IIB, IIIB, IVB, VB, and VIB metal, D is at least one of oxygen, nitrogen, carbon, or a halogen. The positive electroactive material can be an olivine structure compound LiMPO₄, where M is one or more of V, Cr, Mn, Fe, Co, and Ni, in which the compound is optionally doped at the Li, M or O-sites. Deficiencies at the Li-site are compensated by the addition of a metal or metalloid, and deficiencies at the O-site are compensated by the addition of a halogen. In some embodiments, the positive active material comprises a thermally stable, transition-metal-doped lithium transition metal phosphate having the olivine structure and having the formula (Li₁₋ₓZₓ)MPO₄, where M is one or more of V, Cr, Mn, Fe, Co, and Ni, and Z is a non-alkali metal dopant such as one or more of Ti, Zr, Nb, Al, or Mg, and x ranges from 0.005 to 0.05.

In some embodiments, the conductive material can include allotropes of carbon including activated carbon, hard carbon, soft carbon, Ketjen, carbon black, graphitic carbon, carbon fibers, carbon microfibers, vapor-grown carbon fibers (VGCF), fullerenic carbons including “buckyballs”, carbon nanotubes (CNTs), multiwall carbon nanotubes (MWNTs), single wall carbon nanotubes (SWNTs), graphene sheets or aggregates of graphene sheets, and materials comprising fullerenic fragments, or any combination thereof. In some embodiments, the active material, the conductive material, and/or the electrolyte solution can include any of the materials described in U.S. Pat. No. 9,437,864 (“the '864 patent”), filed Mar. 10, 2014, titled “Asymmetric Battery Having a Semi-solid Cathode and High Energy Density Anode,” the disclosure of which is hereby incorporated by reference in its entirety.

In some embodiments, the non-aqueous liquid electrolyte can include an electrolyte solvent and an electrolyte salt. In some embodiments, the electrolyte solvent can include vinylene carbonate (VC), 1,3 propane sultone (PS), ethyl propionate (EP), 1,3-propanediol cyclic sulfate (PSA/TS), fluoroethylene carbonate (FEC), ethylene sulfite (ES), tris(2-ethylhexyl) phosphate (TOP), 1,3,2-Dioxathiolane 2,2-dioxide (DTD), ethyl acetate (EA), maleic anhydride (MA), ethylene carbonate (EC), propylene carbonate (PC), dimethyl carbonate (DMC), ethyl methyl carbonate (EMC), or combinations thereof. In some embodiments, the electrolyte salt can include lithium bis(oxalato)borate (LiBOB), lithium hexafluorophosphate (LiPF₆), lithium bis(fluorosulfony)imide (LiFSI), or any combination thereof.

In some embodiments, the electrolyte salt can have a concentration in the electrolyte solution of at least about 1.5 M, at least about 2 M, at least about 2.5 M, at least about 3 M, at least about 3.5 M, at least about 4 M, at least about 4.5 M, at least about 5 M, at least about 5.5 M, at least about 6 M, at least about 6.5 M, at least about 7 M, at least about 7.5 M, at least about 8 M, at least about 8.5 M, at least about 9 M, or at least about 9.5 M. In some embodiments, the electrolyte salt can have a concentration in the electrolyte solution of no more than about 10 M, no more than about 9.5 M, no more than about 9 M, no more than about 8.5 M, no more than about 8 M, no more than about 7.5 M, no more than about 7 M, no more than about 6.5 M, no more than about 5 M, no more than about 5.5 M, no more than about 5 M, no more than about 4.5 M, no more than about 4 M, no more than about 3.5 M, no more than about 3 M, no more than about 2.5 M, or no more than about 2 M. Combinations of the above-referenced salt concentrations are also possible (e.g., at least about 1.5 M and no more than about 10 M or at least about 3 M and no more than about 5 M), inclusive of all values and ranges therebetween. In some embodiments, the electrolyte salt can have a concentration in the electrolyte solution of about 1.5 M, about 2 M, about 2.5 M, about 3 M, about 3.5 M, about 4 M, about 4.5 M, about 5 M, about 5.5 M, about 6 M, about 6.5 M, about 7 M, about 7.5 M, about 8 M, about 8.5 M, about 9 M, about 9.5 M, or about 10 M.

In some embodiments, the electrolyte can include a single salt. In some embodiments, the electrolyte can include about 2, about 3, about 4, about 5, about 6, about 7, about 8, about 9, or about 10 salts, inclusive of all values and ranges therebetween. In some embodiments, the electrolyte salt can include LiFSi, LiPF₆, or any combination thereof. For example, the electrolyte salt can include about 2 M LiFSI. AS an additional example, the electrolyte salt can include about 1.5 M LiPF₆ with about 0.5 M LiFSI.

In some embodiments, the electrolyte can include a single electrolyte solvent. In some embodiments, the electrolyte can include about 2, about 3, about 4, about 5, about 6, about 7, about 8, about 9, or about 10 electrolyte solvents, inclusive of all values and ranges therebetween. In some embodiments, the electrolyte solvent can include EC, PC, EMC, MA, or any combination thereof, and at any ratio. For example, the electrolyte solvent can include EC/PC/EMC at a ratio of about 2 parts (by weight) EC to about 1 part PC to about 7 parts EMC. As an additional example, the electrolyte solvent can include EC/PC/EMC/MA at a ratio of about 2 parts EC to about 1 part PC to about 3 parts EMC to about 4 parts MA.

In some embodiments, the electrolyte can include additives or combinations of additives. In some embodiments, the electrolyte can include about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt %, inclusive of all values and ranges therebetween. In some embodiments, the additive can include VC, DTD, 1,1,2,2-tetrafluoroethyl-2,2,3,3-tetrafluoropropyl ether (TTE), lithium difluoro(oxalato)borate (LiDFOB), FEC, tris(trimethylsilyl) phosphate (TMSP8), tris(2,2,2-trifuoroethyl) borat(TTFEB), 1,4-butane sultone (BuS), lithium difluorophosphate or any combination thereof. For example, the electrolyte can include about 0.5 wt % to about 2 wt % VC, about 1 wt % to about 1.5 wt % DTD, about 0.5 wt % to about 3 wt % TTE, and about 0.5 wt % to about 1 wt % LiDFOB. As an additional example, the electrolyte can include about 0.5 wt % to about 2 wt % VC, about 1 wt % to about 1.5 wt % DTD, about 0.5 wt % to about 3 wt % TTE, about 0.5 wt % to about 1 wt % LiDFOB, and about 0.1 wt % to about 1 wt % FEC. As an additional example, the electrolyte can include about 0.5 wt % to about 2 wt % VC, about 1 wt % to about 1.5 wt % DTD, about 0.5 wt % to about 3 wt % TTE, about 0.5 wt % to about 1 wt % LiDFOB, and about 0.1 wt % to about 1 wt % TMSP8. As an additional example, the electrolyte can include about 0.5 wt % to about 2 wt % VC, about 1 wt % to about 1.5 wt % DTD, and about 0.5 wt % to about 2 wt % TTFEB. As an additional example, the electrolyte can include about 0.5 wt % to about 2 wt % VC and about 0.5 wt % to about 1 wt % BuS. As an additional example, the electrolyte can include about 0.5 wt % to about 2 wt % VC and about 0.5 wt % to about 1 wt % LiPO₂F₂. As an additional example, the electrolyte can include about 0.5 wt % to about 2 wt % VC, about 0.5 wt % to about 1 wt % BuS, and about 0.5 wt % to about 1 wt % LiPO₂F₂.

In some embodiments, the active material, the conductive material, and/or the electrolyte solution can be combined via mixing, high shear mixing, planetary mixing, centrifugal planetary mixing, sigma mixing, crack attenuating mix (CAM) mixing, roller mixing, or any combination thereof. In some embodiments, the active material, the conductive material, and/or the electrolyte solution can be mixed together with a mixing index of at least about 0.8, at least about 0.85, at least about 0.9, at least about 0.95, or at least about 0.975, inclusive of all values and ranges therebetween. In some embodiments, the active material, the conductive material, and/or the electrolyte solution can be combined via any of the mixing methods described in U.S. Patent publication No. 2017/0162863 (the '863 publication), filed Sep. 15, 2016, and titled “Electrochemical Slurry Compositions and Methods for Preparing the Same,” the entire disclosure of which is hereby incorporated by reference.

Step 12 includes disposing the semi-solid electrode onto a first current collector. In some embodiments, the semi-solid electrode can be dispensed and/or extruded via a sheet extrusion die, a profile-style sheet extrusion die, an arbitrary nozzle, a single-screw extruder, a twin-screw extruder, or an injection mold. In some embodiments, the semi-solid electrode can have a viscosity (at 25° C.) of at least about 100 Pa·s, at least about 150 Pa·s, at least about 200 Pa·s, at least about 250 Pa·s, at least about 300 Pa·s, at least about 350 Pa·s, at least about 400 Pa·s, at least about 450 Pa·s, at least about 500 Pa·s, at least about 550 Pa·s, at least about 600 Pa·s, at least about 650 Pa·s, at least about 700 Pa·s, at least about 750 Pa·s, at least about 800 Pa·s, at least about 850 Pa·s, at least about 900 Pa·s, or at least about 950 Pa·s. In some embodiments, the semi-solid electrode can have a viscosity of no more than about 1,000 Pa·s, no more than about 950 Pa·s, no more than about 900 Pa·s, no more than about 850 Pa·s, no more than about 800 Pa·s, no more than about 750 Pa·s, no more than about 700 Pa·s, no more than about 650 Pa·s, no more than about 600 Pa·s, no more than about 550 Pa·s, no more than about 500 Pa·s, no more than about 450 Pa·s, no more than about 400 Pa·s, no more than about 350 Pa·s, no more than about 300 Pa·s, no more than about 250 Pa·s, no more than about 200 Pa·s, or no more than about 950 Pa·s. Combinations of the above-referenced viscosities are also possible (e.g., at least about 100 Pa·s and no more than about 1,000 Pa·s or at least about 300 Pa·s and no more than about 600 Pa·s), inclusive of all values and ranges therebetween. In some embodiments, the semi-solid electrode can have a viscosity of about 100 Pa·s, about 150 Pa·s, about 200 Pa·s, about 250 Pa·s, about 300 Pa·s, about 350 Pa·s, about 400 Pa·s, about 450 Pa·s, about 500 Pa·s, about 550 Pa·s, about 600 Pa·s, about 650 Pa·s, about 700 Pa·s, about 750 Pa·s, about 800 Pa·s, about 850 Pa·s, about 900 Pa·s, about 950 Pa·s, or about 1,000 Pa·s.

Upon disposing the semi-solid electrode onto the first current collector, the semi-solid electrode has a thickness. In some embodiments, the thickness of the semi-solid electrode can be at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, at least about 950 μm, at least about 1,000 μm, at least about 1,050 μm, at least about 1,100 μm, at least about 1,150 μm, at least about 1,200 μm, at least about 1,250 μm, at least about 1,300 μm, at least about 1,350 μm, at least about 1,400 μm, at least about 1,450 μm, at least about 1,500 μm, at least about 1,550 μm, at least about 1,600 μm, at least about 1,650 μm, at least about 1,700 μm, at least about 1,750 μm, at least about 1,800 μm, at least about 1,850 μm, at least about 1,900 μm, or at least about 1,950 μm. In some embodiments, the thickness of the semi-solid electrode can be no more than about 2,000 μm, no more than about 1,950 μm, no more than about 1,900 μm, no more than about 1,850 μm, no more than about 1,800 μm, no more than about 1,750 μm, no more than about 1,700 μm, no more than about 1,650 μm, no more than about 1,600 μm, no more than about 1,550 μm, no more than about 1,500 μm, no more than about 1,450 μm, no more than about 1,400 μm, no more than about 1,350 μm, no more than about 1,300 μm, no more than about 1,250 μm, no more than about 1,200 μm, no more than about 1,150 μm, no more than about 1,100 μm, no more than about 1,050 μm, no more than about 1,000 μm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, or no more than about 150 μm. Combinations of the above-referenced thicknesses are also possible (e.g., at least about 100 μm and no more than about 2,000 μm or at least about 300 μm and no more than about 1,000 μm), inclusive of all values and ranges therebetween. In some embodiments, the thickness of the semi-solid electrode can be about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1,000 μm, about 1,050 μm, about 1,100 μm, about 1,150 μm, about 1,200 μm, about 1,250 μm, about 1,300 μm, about 1,350 μm, about 1,400 μm, about 1,450 μm, about 1,500 μm, about 1,550 μm, about 1,600 μm, about 1,650 μm, about 1,700 μm, about 1,750 μm, about 1,800 μm, about 1,850 μm, about 1,900 μm, about 1,950 μm, or about 2,000 μm.

At step 13, the method 10 optionally includes disposing a second electrode onto a second current collector. In some embodiments, the second electrode can include an anode. In some embodiments, the second electrode can include a cathode. In some embodiments, the second electrode can include a semi-solid electrode. In some embodiments, the second electrode can include a solid or “conventional” electrode.

Upon disposing the second electrode onto the second current collector, the second electrode has a thickness. In some embodiments, the second electrode can have a thickness of at least about 20 μm, at least about 30 μm, at least about 40 μm, at least about 50 μm, at least about 60 μm, at least about 70 μm, at least about 80 μm, or at least about 90 μm. In some embodiments, the second electrode can have a thickness of no more than about 100 μm, no more than about 90 μm, no more than about 80 μm, no more than about 70 μm, no more than about 60 μm, no more than about 50 μm, no more than about 40 μm, or no more than about 30 μm. Combinations of the above-referenced thicknesses of the second electrode are also possible (e.g., at least about 20 μm and no more than about 100 μm or at least about 40 μm and no more than about 80 μm), inclusive of all values and ranges therebetween. In some embodiments, the second electrode can have a thickness of about 20 μm, about 30 μm, about 40 μm, about 50 μm, about 60 μm, about 70 μm, about 80 μm, about 90 μm, or about 100 μm.

At step 14, the method 10 includes wetting a first surface of the separator with the non-aqueous liquid electrolyte. In some embodiments, the wetting can be via spraying, brushing, injection (e.g., with a syringe), inkjet printing, slot-die dripping, coating, or any other suitable means of application. In some embodiments, the non-aqueous liquid electrolyte coated onto the first surface of the separator can have the same or substantially similar concentration to the non-aqueous liquid electrolyte included in the semi-solid electrode. In some embodiments, both sides of the separator can be coated with non-aqueous liquid electrolyte.

Step 15 includes coating the first surface of the separator with a carbon coating. In some embodiments, the carbon coating can include hard carbon, disordered carbon, graphite, graphitic or non-graphitic carbon, amorphous carbon, mesocarbon, microbeads, soft carbon, activated carbon, a graphitic hard carbon mixture, or any combination thereof. In some embodiments, the carbon coating can include crystalline and amorphous portions. In some embodiments, the carbon coating can include activated carbon, Ketjen, carbon nanotubes, carbon fibers, or any combination thereof. In some embodiments, the non-aqueous electrolyte can facilitate the carbon coating to cling to the first surface of the carbon coating.

Step 16 is optional and includes disposing the second electrode onto the semi-solid electrode with a separator interposed between the second electrode and the semi-solid electrode. This forms an electrochemical cell. The first surface of the separator (i.e., the surface of the separator coated with the non-aqueous liquid electrolyte solution and the carbon coating) contacts the semi-solid electrode. The non-aqueous liquid electrolyte solution and the carbon coating facilitate electrochemical contact between the semi-solid electrode and the separator.

Step 17 is optional and includes charging and discharging the electrochemical cell in a horizontal orientation. In other words, the electrochemical cell is charged and discharged with the electrodes oriented horizontally such that gravity acts in the direction of the thickness of the electrodes. The gravity creates a density gradient and a salt concentration gradient within the high-viscosity semi-solid electrode. In some embodiments, the density gradient can be created via a magnetic field. In some embodiments, the density gradient can be created via heating the semi-solid electrode. In some embodiments, the density gradient can be created by centrifugal force.

In some embodiments, the electrochemical cell can be rotated about a central axis while operating the electrochemical cell. In some embodiments, multiple electrochemical cells can be rotated about a central axis to create a density gradient.

In some embodiments, the electrochemical cell can be charged at a rate of at least about 1 C, at least about 1.5 C, at least about 2 C, at least about 2.5 C, at least about 3 C, at least about 3.5 C, at least about 4 C, at least about 4.5 C, at least about 5 C, at least about 5.5 C, at least about 6 C, at least about 6.5 C, at least about 7 C, at least about 7.5 C, at least about 8 C, at least about 8.5 C, at least about 9 C, at least about 9.5 C, or at least about 10 C, inclusive of all values and ranges therebetween. In some embodiments, the electrochemical cell can be discharged at a rate of at least about 1 C, at least about 1.5 C, at least about 2 C, at least about 2.5 C, at least about 3 C, at least about 3.5 C, at least about 4 C, at least about 4.5 C, at least about 5 C, at least about 5.5 C, at least about 6 C, at least about 6.5 C, at least about 7 C, at least about 7.5 C, at least about 8 C, at least about 8.5 C, at least about 9 C, at least about 9.5 C, or at least about 10 C, inclusive of all values and ranges therebetween.

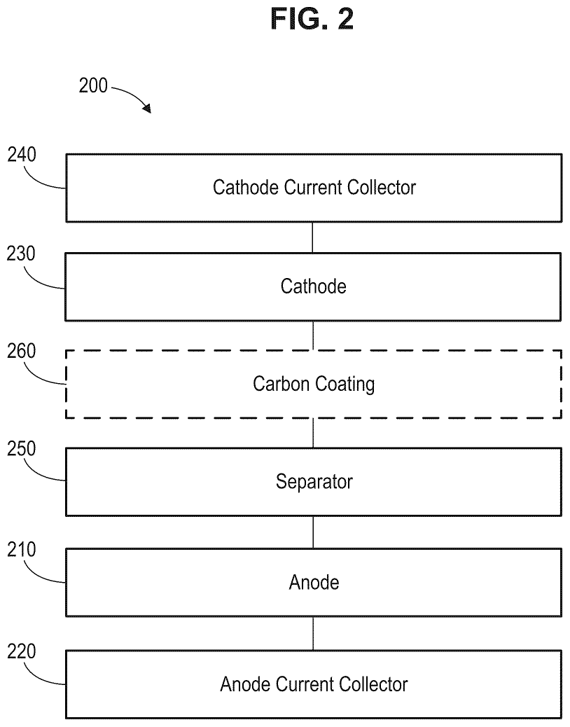

FIG. 2 is a block diagram of an electrochemical cell 200, according to an embodiment. As shown, the electrochemical cell 200 includes an anode 210 disposed on an anode current collector 220, a cathode 230 disposed on a cathode current collector 240, with a separator 250 disposed between the anode 210 and the cathode 230. A carbon coating 260 is optionally disposed between the cathode 230 and the separator 250.

The anode 210 includes an anode active material. In some embodiments, the anode 210 can include any of the anode materials listed above. In some embodiments, the anode 210 can include a semi-solid anode. In some embodiments, the anode 210 can have an electrolyte salt concentration of at least about 500 mol/m³, at least about 1,000 mol/m³, at least about 1,500 mol/m³, at least about 2,000 mol/m³, at least about 2,100 mol/m³, at least about 2,200 mol/m³, at least about 2,300 mol/m³, at least about 2,400 mol/m³, at least about 2,500 mol/m³, at least about 3,000 mol/m³, at least about 3,500 mol/m³, at least about 4,000 mol/m³, at least about 4,500 mol/m³, at least about 5,000 mol/m³, at least about 5,500 mol/m³, at least about 6,000 mol/m³, at least about 6,500 mol/m³, at least about 7,000 mol/m³, at least about 7,500 mol/m³, at least about 8,000 mol/m³, at least about 8,500 mol/m³, at least about 9,000 mol/m³, or at least about 9,500 mol/m³. In some embodiments, the anode 210 can have an electrolyte salt concentration of no more than about 10,000 mol/m³, no more than about 9,500 mol/m³, no more than about 9,000 mol/m³, no more than about 8,500 mol/m³, no more than about 8,000 mol/m³, no more than about 7,500 mol/m³, no more than about 7,000 mol/m³, no more than about 6,500 mol/m³, no more than about 6,000 mol/m³, no more than about 5,500 mol/m³, no more than about 5,000 mol/m³, no more than about 4,500 mol/m³, no more than about 4,000 mol/m³, no more than about 3,500 mol/m³, no more than about 3,000 mol/m³, no more than about 2,500 mol/m³, no more than about 2,400 mol/m³, no more than about 2,300 mol/m³, no more than about 2,200 mol/m³, no more than about 2,100 mol/m³, no more than about 2,000 mol/m³, no more than about 1,500 mol/m³, or no more than about 1,000 mol/m³. Combinations of the above-referenced electrolyte salt concentrations in the anode 210 are also possible (e.g., at least about 500 mol/m³ and no more than about 10,000 mol/m³ or at least about 2,000 mol/m³ and no more than about 5,000 mol/m³), inclusive of all values and ranges therebetween. In some embodiments, the anode 210 can have an electrolyte salt concentration of about 500 mol/m³, about 1,000 mol/m³, about 1,500 mol/m³, about 2,000 mol/m³, about 2,100 mol/m³, about 2,200 mol/m³, about 2,300 mol/m³, about 2,400 mol/m³, about 2,500 mol/m³, about 3,000 mol/m³, about 3,500 mol/m³, about 4,000 mol/m³, about 4,500 mol/m³, about 5,000 mol/m³, about 5,500 mol/m³, about 6,000 mol/m³, about 6,500 mol/m³, about 7,000 mol/m³, about 7,500 mol/m³, about 8,000 mol/m³, about 8,500 mol/m³, about 9,000 mol/m³, about 9,500 mol/m³, or about 10,000 mol/m³. In some embodiments, electrolyte salt concentrations can be measured directly. In some embodiments, electrolyte salt concentrations can be estimated via a finite element modeling-based simulations.

In some embodiments, the anode 210 can have an electrolyte salt concentration gradient along the thickness of the anode 210. In some embodiments, the concentration gradient can be present while the electrochemical cell 200 is charging. In some embodiments, the concentration gradient can be present while the electrochemical cell 200 is discharging. In some embodiments, the concentration gradient can be present while the electrochemical cell 200 is dormant. In some embodiments, the anode 210 can have an average electrolyte salt concentration gradient of at least about 1×10⁷ mol/m⁴, at least about 1.1×10⁷ mol/m⁴, at least about 1.2×10⁷ mol/m⁴, at least about 1.3×10⁷ mol/m⁴, at least about 1.4×10⁷ mol/m⁴, at least about 1.5×10⁷ mol/m⁴, at least about 1.6×10⁷ mol/m⁴, at least about 1.7×10⁷ mol/m⁴, at least about 1.8×10⁷ mol/m⁴, at least about 1.9×10⁷ mol/m⁴, at least about 2×10⁷ mol/m⁴, at least about 2.1×10⁷ mol/m⁴, at least about 2.2×10⁷ mol/m⁴, at least about 2.3×10⁷ mol/m⁴, at least about 2.4×10⁷ mol/m⁴, at least about 2.5×10⁷ mol/m⁴, at least about 2.6×10⁷ mol/m⁴, at least about 2.7×10⁷ mol/m⁴, at least about 2.8×10⁷ mol/m⁴, at least about 2.9×10⁷ mol/m⁴, at least about 3×10⁷ mol/m⁴, at least about 3.1×10⁷ mol/m⁴, at least about 3.2×10⁷ mol/m⁴, at least about 3.3×10⁷ mol/m⁴, at least about 3.4×10⁷ mol/m⁴, at least about 3.5×10⁷ mol/m⁴, at least about 3.6×10⁷ mol/m⁴, at least about 3.7×10⁷ mol/m⁴, at least about 3.8×10⁷ mol/m⁴, at least about 3.9×10⁷ mol/m⁴, at least about 4×10⁷ mol/m⁴, at least about 4.1×10⁷ mol/m⁴, at least about 4.2×10⁷ mol/m⁴, at least about 4.3×10⁷ mol/m⁴, at least about 4.4×10⁷ mol/m⁴, at least about 4.5×10⁷ mol/m⁴, at least about 4.6×10⁷ mol/m⁴, at least about 4.7×10⁷ mol/m⁴, at least about 4.8×10⁷ mol/m⁴, at least about 4.9×10⁷ mol/m⁴. In some embodiments, the anode 210 can have an average electrolyte salt concentration gradient of no more than about 5×10⁷ mol/m⁴, no more than about 4.9×10⁷ mol/m⁴, no more than about 4.8×10⁷ mol/m⁴, no more than about 4.7×10⁷ mol/m⁴, no more than about 4.6×10⁷ mol/m⁴, no more than about 4.5×10⁷ mol/m⁴, no more than about 4.4×10⁷ mol/m⁴, no more than about 4.3×10⁷ mol/m⁴, no more than about 4.2×10⁷ mol/m⁴, no more than about 4.1×10⁷ mol/m⁴, no more than about 4×10⁷ mol/m⁴, no more than about 3.9×10⁷ mol/m⁴, no more than about 3.8×10⁷ mol/m⁴, no more than about 3.7×10⁷ mol/m⁴, no more than about 3.6×10⁷ mol/m⁴, no more than about 3.5×10⁷ mol/m⁴, no more than about 3.4×10⁷ mol/m⁴, no more than about 3.3×10⁷ mol/m⁴, no more than about 3.2×10⁷ mol/m⁴, no more than about 3.1×10⁷ mol/m⁴, no more than about 3×10⁷ mol/m⁴, no more than about 2.9×10⁷ mol/m⁴, no more than about 2.8×10⁷ mol/m⁴, no more than about 2.7×10⁷ mol/m⁴, no more than about 2.6×10⁷ mol/m⁴, no more than about 2.5×10⁷ mol/m⁴, no more than about 2.4×10⁷ mol/m⁴, no more than about 2.3×10⁷ mol/m⁴, no more than about 2.2×10⁷ mol/m⁴, no more than about 2.1×10⁷ mol/m⁴, no more than about 2×10⁷ mol/m⁴, no more than about 1.9×10⁷ mol/m⁴, no more than about 1.8×10⁷ mol/m⁴, no more than about 1.7×10⁷ mol/m⁴, no more than about 1.6×10⁷ mol/m⁴, no more than about 1.5×10⁷ mol/m⁴, no more than about 1.4×10⁷ mol/m⁴, no more than about 1.3×10⁷ mol/m⁴, no more than about 1.2×10⁷ mol/m⁴, or no more than about 1.1×10⁷ mol/m⁴.

Combinations of the above-referenced average electrolyte salt concentration gradients are also possible (e.g., at least about 1×10⁷ mol/m⁴ and no more than about 5×10⁷ mol/m⁴ or at least about 2 mol/m⁴ and no more than about 4 mol/m⁴), inclusive of all values and ranges therebetween. In some embodiments, the anode 210 can have an average electrolyte salt concentration gradient of about 1.0×10⁷ mol/m⁴, about 1.1×10⁷ mol/m⁴, about 1.2×10⁷ mol/m⁴, about 1.3×10⁷ mol/m⁴, about 1.4×10⁷ mol/m⁴, about 1.5×10⁷ mol/m⁴, about 1.6×10⁷ mol/m⁴, about 1.7×10⁷ mol/m⁴, about 1.8×10⁷ mol/m⁴, about 1.9×10⁷ mol/m⁴, about 2.0×10⁷ mol/m⁴, about 2.1×10⁷ mol/m⁴, about 2.2×10⁷ mol/m⁴, about 2.3×10⁷ mol/m⁴, about 2.4×10⁷ mol/m⁴, about 2.5×10⁷ mol/m⁴, about 2.6×10⁷ mol/m⁴, about 2.7×10⁷ mol/m⁴, about 2.8×10⁷ mol/m⁴, about 2.9×10⁷ mol/m⁴, about 3.0×10⁷ mol/m⁴, about 3.1×10⁷ mol/m⁴, about 3.2×10⁷ mol/m⁴, about 3.3×10⁷ mol/m⁴, about 3.4×10⁷ mol/m⁴, about 3.5×10⁷ mol/m⁴, about 3.6×10⁷ mol/m⁴, about 3.7×10⁷ mol/m⁴, about 3.8×10⁷ mol/m⁴, about 3.9×10⁷ mol/m⁴, about 4.0×10⁷ mol/m⁴, about 4.1×10⁷ mol/m⁴, about 4.2×10⁷ mol/m⁴, about 4.3×10⁷ mol/m⁴, about 4.4×10⁷ mol/m⁴, about 4.5×10⁷ mol/m⁴, about 4.6×10⁷ mol/m⁴, about 4.7×10⁷ mol/m⁴, about 4.8×10⁷ mol/m⁴, about 4.9×10⁷ mol/m⁴, or about 5.0×10⁷ mol/m⁴.

In some embodiments, the anode 210 can have a density gradient. In some embodiments, the density gradient can be present while the electrochemical cell 200 is charging. In some embodiments, the density gradient can be present while the electrochemical cell 200 is discharging. In some embodiments, the density gradient can be present while the electrochemical cell 200 is dormant. In some embodiments, the anode 210 can have an average density gradient of at least about 1×10⁵ kg/m⁴, at least about 2×10⁵ kg/m⁴, at least about 3×10⁵ kg/m⁴, at least about 4×10⁵ kg/m⁴, at least about 5×10⁵ kg/m⁴, at least about 6×10⁵ kg/m⁴, at least about 7×10⁵ kg/m⁴, at least about 8×10⁵ kg/m⁴, at least about 9×10⁵ kg/m⁴, at least about 1×10⁶ kg/m⁴, at least about 2×10⁶ kg/m⁴, at least about 3×10⁶ kg/m⁴, at least about 4×10⁶ kg/m⁴, at least about 5×10⁶ kg/m⁴, at least about 6×10⁶ kg/m⁴, at least about 7×10⁶ kg/m⁴, at least about 8×10⁶ kg/m⁴, at least about 9×10⁶ kg/m⁴, at least about 1×10⁷ kg/m⁴, at least about 2×10⁷ kg/m⁴, at least about 3×10⁷ kg/m⁴, at least about 4×10⁷ kg/m⁴, at least about 5×10⁷ kg/m⁴, at least about 6×10⁷ kg/m⁴, at least about 7×10⁷ kg/m⁴, at least about 8×10⁷ kg/m⁴, at least about 9×10⁷ kg/m⁴, at least about 1×10′ kg/m⁴, at least about 2×10′ kg/m⁴, at least about 3×10′ kg/m⁴, at least about 4×10′ kg/m⁴, at least about 5×10⁸ kg/m⁴, at least about 6×10⁸ kg/m⁴, at least about 7×10⁸ kg/m⁴, at least about 8×10⁸ kg/m⁴, or at least about 9×10′ kg/m⁴. In some embodiments, the anode 210 can have an average concentration gradient of no more than about 1×10⁹ kg/m⁴, no more than about 9×10′ kg/m⁴, no more than about 8×10⁸ kg/m⁴, no more than about 7×10′ kg/m⁴, no more than about 6×10⁸ kg/m⁴, no more than about 5×10⁸ kg/m⁴, no more than about 4×10⁸ kg/m⁴, no more than about 3×10⁸ kg/m⁴, no more than about 2×10⁸ kg/m⁴, no more than about 1×10′ kg/m⁴, no more than about 9×10⁷ kg/m⁴, no more than about 8×10⁷ kg/m⁴, no more than about 7×10⁷ kg/m⁴, no more than about 6×10⁷ kg/m⁴, no more than about 5×10⁷ kg/m⁴, no more than about 4×10⁷ kg/m⁴, no more than about 3×10⁷ kg/m⁴, no more than about 2×10⁷ kg/m⁴, no more than about 1×10⁷ kg/m⁴, no more than about 9×10⁶ kg/m⁴, no more than about 8×10⁶ kg/m⁴, no more than about 7×10⁶ kg/m⁴, no more than about 6×10⁶ kg/m⁴, no more than about 5×10⁶ kg/m⁴, no more than about 4×10⁶ kg/m⁴, no more than about 3×10⁶ kg/m⁴, no more than about 2×10⁶ kg/m⁴, no more than about 1×10⁶ kg/m⁴, no more than about 9×10⁵ kg/m⁴, no more than about 8×10⁵ kg/m⁴, no more than about 7×10⁵ kg/m⁴, no more than about 6×10⁵ kg/m⁴, no more than about 5×10⁵ kg/m⁴, no more than about 4×10⁵ kg/m⁴, no more than about 3×10⁵ kg/m⁴, or no more than about 2×10⁵ kg/m⁴.

Combinations of the above-referenced average concentration gradients are also possible (e.g., at least about 1×10⁵ kg/m⁴ and no more than about 1×10⁹ kg/m⁴ or at least about 1×10⁶ kg/m⁴ and no more than about 1×10⁸ kg/m⁴), inclusive of all values and ranges therebetween. In some embodiments, the anode 210 can have an average concentration gradient of about 1×10⁵ kg/m⁴, about 2×10⁵ kg/m⁴, about 3×10⁵ kg/m⁴, about 4×10⁵ kg/m⁴, about 5×10⁵ kg/m⁴, about 6×10⁵ kg/m⁴, about 7×10⁵ kg/m⁴, about 8×10⁵ kg/m⁴, about 9×10⁵ kg/m⁴, about 1×10⁶ kg/m⁴, about 2×10⁶ kg/m⁴, about 3×10⁶ kg/m⁴, about 4×10⁶ kg/m⁴, about 5×10⁶ kg/m⁴, about 6×10⁶ kg/m⁴, about 7×10⁶ kg/m⁴, about 8×10⁶ kg/m⁴, about 9×10⁶ kg/m⁴, about 1×10⁷ kg/m⁴, about 2×10⁷ kg/m⁴, about 3×10⁷ kg/m⁴, about 4×10⁷ kg/m⁴, about 5×10⁷ kg/m⁴, about 6×10⁷ kg/m⁴, about 7×10⁷ kg/m⁴, about 8×10⁷ kg/m⁴, about 9×10⁷ kg/m⁴, about 1×10′ kg/m⁴, about 2×10⁸ kg/m⁴, about 3×10′ kg/m⁴, about 4×10′ kg/m⁴, about 5×10⁸ kg/m⁴, about 6×10′ kg/m⁴, about 7×10⁸ kg/m⁴, about 8×10⁸ kg/m⁴, about 9×10′ kg/m⁴, or about 1×10⁹ kg/m⁴.

In some embodiments, the anode 210 can have a viscosity (at 25° C.) of at least about 100 Pa·s, at least about 150 Pa·s, at least about 200 Pa·s, at least about 250 Pa·s, at least about 300 Pa·s, at least about 350 Pa·s, at least about 400 Pa·s, at least about 450 Pa·s, at least about 500 Pa·s, at least about 550 Pa·s, at least about 600 Pa·s, at least about 650 Pa·s, at least about 700 Pa·s, at least about 750 Pa·s, at least about 800 Pa·s, at least about 850 Pa·s, at least about 900 Pa·s, or at least about 950 Pa·s. In some embodiments, the anode 210 can have a viscosity of no more than about 1,000 Pa·s, no more than about 950 Pa·s, no more than about 900 Pa·s, no more than about 850 Pa·s, no more than about 800 Pa·s, no more than about 750 Pa·s, no more than about 700 Pa·s, no more than about 650 Pa·s, no more than about 600 Pa·s, no more than about 550 Pa·s, no more than about 500 Pa·s, no more than about 450 Pa·s, no more than about 400 Pa·s, no more than about 350 Pa·s, no more than about 300 Pa·s, no more than about 250 Pa·s, no more than about 200 Pa·s, or no more than about 950 Pa·s. Combinations of the above-referenced viscosities are also possible (e.g., at least about 100 Pa·s and no more than about 1,000 Pa·s or at least about 300 Pa·s and no more than about 600 Pa·s), inclusive of all values and ranges therebetween. In some embodiments, the anode 210 can have a viscosity of about 100 Pa·s, about 150 Pa·s, about 200 Pa·s, about 250 Pa·s, about 300 Pa·s, about 350 Pa·s, about 400 Pa·s, about 450 Pa·s, about 500 Pa·s, about 550 Pa·s, about 600 Pa·s, about 650 Pa·s, about 700 Pa·s, about 750 Pa·s, about 800 Pa·s, about 850 Pa·s, about 900 Pa·s, about 950 Pa·s, or about 1,000 Pa·s.

In some embodiments, the anode 210 can have a viscosity gradient. In some embodiments, the viscosity gradient can be present while the electrochemical cell 200 is charging. In some embodiments, the viscosity gradient can be present while the electrochemical cell 200 is discharging. In some embodiments, the viscosity gradient can be present while the electrochemical cell 200 is dormant. In some embodiments, the anode 210 can have an average viscosity gradient of at least about 1×10⁵ Pa·s/m, at least about 2×10⁵ Pa·s/m, at least about 3×10⁵ Pa·s/m, at least about 4×10⁵ Pa·s/m, at least about 5×10⁵ Pa·s/m, at least about 6×10⁵ Pa·s/m, at least about 7×10⁵ Pa·s/m, at least about 8×10⁵ Pa·s/m, at least about 9×10⁵ Pa·s/m, at least about 1×10⁶ Pa·s/m, at least about 2×10⁶ Pa·s/m, at least about 3×10⁶ Pa·s/m, at least about 4×10⁶ Pa·s/m, at least about 5×10⁶ Pa·s/m, at least about 6×10⁶ Pa·s/m, at least about 7×10⁶ Pa·s/m, at least about 8×10⁶ Pa·s/m, at least about 9×10⁶ Pa·s/m, at least about 1×10⁷ Pa·s/m, at least about 2×10⁷ Pa·s/m, at least about 3×10⁷ Pa·s/m, at least about 4×10⁷ Pa·s/m, at least about 5×10⁷ Pa·s/m, at least about 6×10⁷ Pa·s/m, at least about 7×10⁷ Pa·s/m, at least about 8×10⁷ Pa·s/m, at least about 9×10⁷ Pa·s/m, at least about 1×10⁸ Pa·s/m, at least about 2×10⁸ Pa·s/m, at least about 3×10⁸ Pa·s/m, at least about 4×10′ Pa·s/m, at least about 5×10⁸ Pa·s/m, at least about 6×10⁸ Pa·s/m, at least about 7×10⁸ Pa·s/m, at least about 8×10⁸ Pa·s/m, or at least about 9×10⁸ Pa·s/m. In some embodiments, the anode 210 can have an average viscosity gradient of no more than about 1×10⁹ Pa·s/m, no more than about 9×10⁸ Pa·s/m, no more than about 8×10⁸ Pa·s/m, no more than about 7×10⁸ Pa·s/m, no more than about 6×10⁸ Pa·s/m, no more than about 5×10⁸ Pa·s/m, no more than about 4×10⁸ Pa·s/m, no more than about 3×10⁸ Pa·s/m, no more than about 2×10⁸ Pa·s/m, no more than about 1×10⁸ Pa·s/m, no more than about 9×10⁷ Pa·s/m, no more than about 8×10⁷ Pa·s/m, no more than about 7×10⁷ Pa·s/m, no more than about 6×10⁷ Pa·s/m, no more than about 5×10⁷ Pa·s/m, no more than about 4×10⁷ Pa·s/m, no more than about 3×10⁷ Pa·s/m, no more than about 2×10⁷ Pa·s/m, no more than about 1×10⁷ Pa·s/m, no more than about 9×10⁶ Pa·s/m, no more than about 8×10⁶ Pa·s/m, no more than about 7×10⁶ Pa·s/m, no more than about 6×10⁶ Pa·s/m, no more than about 5×10⁶ Pa·s/m, no more than about 4×10⁶ Pa·s/m, no more than about 3×10⁶ Pa·s/m, no more than about 2×10⁶ Pa·s/m, no more than about 1×10⁶ Pa·s/m, no more than about 9×10⁵ Pa·s/m, no more than about 8×10⁵ Pa·s/m, no more than about 7×10⁵ Pa·s/m, no more than about 6×10⁵ Pa·s/m, no more than about 5×10⁵ Pa·s/m, no more than about 4×10⁵ Pa·s/m, no more than about 3×10⁵ Pa·s/m, or no more than about 2×10⁵ Pa·s/m.

Combinations of the above-referenced average viscosity gradients are also possible (e.g., at least about 1×10⁵ Pa·s/m and no more than about 1×10⁹ Pa·s/m or at least about 1×10⁶ Pa·s/m and no more than about 1×10⁸ Pa·s/m), inclusive of all values and ranges therebetween. In some embodiments, the anode 210 can have an average viscosity gradient of about 1×10⁵ Pa·s/m, about 2×10⁵ Pa·s/m, about 3×10⁵ Pa·s/m, about 4×10⁵ Pa·s/m, about 5×10⁵ Pa·s/m, about 6×10⁵ Pa·s/m, about 7×10⁵ Pa·s/m, about 8×10⁵ Pa·s/m, about 9×10⁵ Pa·s/m, about 1×10⁶ Pa·s/m, about 2×10⁶ Pa·s/m, about 3×10⁶ Pa·s/m, about 4×10⁶ Pa·s/m, about 5×10⁶ Pa·s/m, about 6×10⁶ Pa·s/m, about 7×10⁶ Pa·s/m, about 8×10⁶ Pa·s/m, about 9×10⁶ Pa·s/m, about 1×10⁷ Pa·s/m, about 2×10⁷ Pa·s/m, about 3×10⁷ Pa·s/m, about 4×10⁷ Pa·s/m, about 5×10⁷ Pa·s/m, about 6×10⁷ Pa·s/m, about 7×10⁷ Pa·s/m, about 8×10⁷ Pa·s/m, about 9×10⁷ Pa·s/m, about 1×10⁸ Pa·s/m, about 2×10⁸ Pa·s/m, about 3×10⁸ Pa·s/m, about 4×10⁸ Pa·s/m, about 5×10⁸ Pa·s/m, about 6×10⁸ Pa·s/m, about 7×10⁸ Pa·s/m, about 8×10⁸ Pa·s/m, about 9×10⁸ Pa·s/m, or about 1×10⁹ Pa·s/m.

In some embodiments, the anode current collector 220 can be composed of copper, aluminum, titanium, or any combination thereof. In some embodiments, the anode current collector 220 can have a thickness of at least about 1 μm, at least about 2 μm, at least about 3 μm, at least about 4 μm, at least about 5 μm, at least about 10 μm, at least about 15 μm, at least about 20 μm, at least about 25 μm, at least about 30 μm, at least about 35 μm, at least about 40 μm, or at least about 45 μm. In some embodiments, the anode current collector 220 can have a thickness of no more than about 50 μm, no more than about 45 μm, no more than about 40 μm, no more than about 35 μm, no more than about 30 μm, no more than about 25 μm, no more than about 20 μm, no more than about 15 μm, no more than about 10 μm, no more than about 5 μm, no more than about 4 μm, no more than about 3 μm, or no more than about 2 μm. Combinations of the above-referenced thicknesses of the anode current collector 220 are also possible (e.g., at least about 1 μm and no more than about 50 μm or at least about 5 μm and no more than about 20 μm), inclusive of all values and ranges therebetween. In some embodiments, the anode current collector 220 can have a thickness of about 1 μm, about 2 μm, about 3 μm, about 4 μm, about 5 μm, about 10 μm, about 15 μm, about 20 μm, about 25 μm, about 30 μm, about 35 μm, about 40 μm, about 45 μm, or about 50 μm.

In some embodiments, the cathode 230 can include a semi-solid cathode. In some embodiments, the cathode 230 can have a thickness of at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, at least about 950 μm, at least about 1,000 μm, at least about 1,050 μm, at least about 1,100 μm, at least about 1,150 μm, at least about 1,200 μm, at least about 1,250 μm, at least about 1,300 μm, at least about 1,350 μm, at least about 1,400 μm, at least about 1,450 μm, at least about 1,500 μm, at least about 1,550 μm, at least about 1,600 μm, at least about 1,650 μm, at least about 1,700 μm, at least about 1,750 μm, at least about 1,800 μm, at least about 1,850 μm, at least about 1,900 μm, or at least about 1,950 μm. In some embodiments, the cathode 230 can have a thickness of no more than about 2,000 μm, no more than about 1,950 μm, no more than about 1,900 μm, no more than about 1,850 μm, no more than about 1,800 μm, no more than about 1,750 μm, no more than about 1,700 μm, no more than about 1,650 μm, no more than about 1,600 μm, no more than about 1,550 μm, no more than about 1,500 μm, no more than about 1,450 μm, no more than about 1,400 μm, no more than about 1,350 μm, no more than about 1,300 μm, no more than about 1,250 μm, no more than about 1,200 μm, no more than about 1,150 μm, no more than about 1,100 μm, no more than about 1,050 μm, no more than about 1,000 μm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, or no more than about 150 μm. Combinations of the above-referenced thicknesses are also possible (e.g., at least about 100 μm and no more than about 2,000 μm or at least about 300 μm and no more than about 1,000 μm), inclusive of all values and ranges therebetween. In some embodiments, the cathode 230 can have a thickness of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1,000 μm, about 1,050 μm, about 1,100 μm, about 1,150 μm, about 1,200 μm, about 1,250 μm, about 1,300 μm, about 1,350 μm, about 1,400 μm, about 1,450 μm, about 1,500 μm, about 1,550 μm, about 1,600 μm, about 1,650 μm, about 1,700 μm, about 1,750 μm, about 1,800 μm, about 1,850 μm, about 1,900 μm, about 1,950 μm, or about 2,000 μm.

In some embodiments, the cathode 230 can have an electrolyte salt concentration of at least about 1,000 mol/m³, at least about 1,500 mol/m³, at least about 2,000 mol/m³, at least about 2,500 mol/m³, at least about 3,000 mol/m³, at least about 3,500 mol/m³, at least about 4,000 mol/m³, at least about 4,500 mol/m³, at least about 5,000 mol/m³, at least about 5,500 mol/m³, at least about 6,000 mol/m³, at least about 6,500 mol/m³, at least about 7,000 mol/m³, at least about 7,500 mol/m³, at least about 8,000 mol/m³, at least about 8,500 mol/m³, at least about 9,000 mol/m³, or at least about 9,500 mol/m³. In some embodiments, the cathode 230 can have an electrolyte salt concentration of no more than about 10,000 mol/m³, no more than about 9,500 mol/m³, no more than about 9,000 mol/m³, no more than about 8,500 mol/m³, no more than about 8,000 mol/m³, no more than about 7,500 mol/m³, no more than about 7,000 mol/m³, no more than about 6,500 mol/m³, no more than about 6,000 mol/m³, no more than about 5,500 mol/m³, no more than about 5,000 mol/m³, no more than about 4,500 mol/m³, no more than about 4,000 mol/m³, no more than about 3,500 mol/m³, no more than about 3,000 mol/m³, or no more than about 2,500 mol/m³, no more than about 2,000 mol/m³, or no more than about 1,500 mol/m³. Combinations of the above-referenced electrolyte salt concentrations in the cathode 230 are also possible (e.g., at least about 1,000 mol/m³ and no more than about 10,000 mol/m³ or at least about 2,000 mol/m³ and no more than about 5,000 mol/m³), inclusive of all values and ranges therebetween. In some embodiments, the cathode 230 can have an electrolyte salt concentration of about 1,000 mol/m³, about 1,500 mol/m³, about 2,000 mol/m³, about 2,500 mol/m³, about 3,000 mol/m³, about 3,500 mol/m³, about 4,000 mol/m³, about 4,500 mol/m³, about 5,000 mol/m³, about 5,500 mol/m³, about 6,000 mol/m³, about 6,500 mol/m³, about 7,000 mol/m³, about 7,500 mol/m³, about 8,000 mol/m³, about 8,500 mol/m³, about 9,000 mol/m³, about 9,500 mol/m³, or about 10,000 mol/m³.

In some embodiments, the cathode 230 can have an electrolyte salt concentration gradient along the thickness of the cathode 230. In some embodiments, the concentration gradient can be present while the electrochemical cell 200 is charging. In some embodiments, the concentration gradient can be present while the electrochemical cell 200 is discharging. In some embodiments, the concentration gradient can be present while the electrochemical cell 200 is dormant. In some embodiments, the cathode 230 can have an average electrolyte salt concentration gradient of at least about 1.0×10⁷ mol/m⁴, at least about 1.1×10⁷ mol/m⁴, at least about 1.2×10⁷ mol/m⁴, at least about 1.3×10⁷ mol/m⁴, at least about 1.4×10⁷ mol/m⁴, at least about 1.5×10⁷ mol/m⁴, at least about 1.6×10⁷ mol/m⁴, at least about 1.7×10⁷ mol/m⁴, at least about 1.8×10⁷ mol/m⁴, at least about 1.9×10⁷ mol/m⁴, at least about 2.0×10⁷ mol/m⁴, at least about 2.1×10⁷ mol/m⁴, at least about 2.2×10⁷ mol/m⁴, at least about 2.3×10⁷ mol/m⁴, at least about 2.4×10⁷ mol/m⁴, at least about 2.5×10⁷ mol/m⁴, at least about 2.6×10⁷ mol/m⁴, at least about 2.7×10⁷ mol/m⁴, at least about 2.8×10⁷ mol/m⁴, at least about 2.9×10⁷ mol/m⁴, at least about 3.0×10⁷ mol/m⁴, at least about 3.1×10⁷ mol/m⁴, at least about 3.2×10⁷ mol/m⁴, at least about 3.3×10⁷ mol/m⁴, at least about 3.4×10⁷ mol/m⁴, at least about 3.5×10⁷ mol/m⁴, at least about 3.6×10⁷ mol/m⁴, at least about 3.7×10⁷ mol/m⁴, at least about 3.8×10⁷ mol/m⁴, at least about 3.9×10⁷ mol/m⁴, at least about 4.0×10⁷ mol/m⁴, at least about 4.1×10⁷ mol/m⁴, at least about 4.2×10⁷ mol/m⁴, at least about 4.3×10⁷ mol/m⁴, at least about 4.4×10⁷ mol/m⁴, at least about 4.5×10⁷ mol/m⁴, at least about 4.6×10⁷ mol/m⁴, at least about 4.7×10⁷ mol/m⁴, at least about 4.8×10⁷ mol/m⁴, at least about 4.9×10⁷ mol/m⁴. In some embodiments, the cathode 230 can have an average electrolyte salt concentration gradient of no more than about 5.0×10⁷ mol/m⁴, no more than about 4.9×10⁷ mol/m⁴, no more than about 4.8×10⁷ mol/m⁴, no more than about 4.7×10⁷ mol/m⁴, no more than about 4.6×10⁷ mol/m⁴, no more than about 4.5×10⁷ mol/m⁴, no more than about 4.4×10⁷ mol/m⁴, no more than about 4.3×10⁷ mol/m⁴, no more than about 4.2×10⁷ mol/m⁴, no more than about 4.1×10⁷ mol/m⁴, no more than about 4.0×10⁷ mol/m⁴, no more than about 3.9×10⁷ mol/m⁴, no more than about 3.8×10⁷ mol/m⁴, no more than about 3.7×10⁷ mol/m⁴, no more than about 3.6×10⁷ mol/m⁴, no more than about 3.5×10⁷ mol/m⁴, no more than about 3.4×10⁷ mol/m⁴, no more than about 3.3×10⁷ mol/m⁴, no more than about 3.2×10⁷ mol/m⁴, no more than about 3.1×10⁷ mol/m⁴, no more than about 3.0×10⁷ mol/m⁴, no more than about 2.9×10⁷ mol/m⁴, no more than about 2.8×10⁷ mol/m⁴, no more than about 2.7×10⁷ mol/m⁴, no more than about 2.6×10⁷ mol/m⁴, no more than about 2.5×10⁷ mol/m⁴, no more than about 2.4×10⁷ mol/m⁴, no more than about 2.3×10⁷ mol/m⁴, no more than about 2.2×10⁷ mol/m⁴, no more than about 2.1×10⁷ mol/m⁴, no more than about 2.0×10⁷ mol/m⁴, no more than about 1.9×10⁷ mol/m⁴, no more than about 1.8×10⁷ mol/m⁴, no more than about 1.7×10⁷ mol/m⁴, no more than about 1.6×10⁷ mol/m⁴, no more than about 1.5×10⁷ mol/m⁴, no more than about 1.4×10⁷ mol/m⁴, no more than about 1.3×10⁷ mol/m⁴, no more than about 1.2×10⁷ mol/m⁴, or no more than about 1.1×10⁷ mol/m⁴.

Combinations of the above-referenced average electrolyte salt concentration gradients are also possible (e.g., at least about 1×10⁷ mol/m⁴ and no more than about 5 mol/m⁴ or at least about 2 mol/m⁴ and no more than about 4 mol/m⁴), inclusive of all values and ranges therebetween. In some embodiments, the cathode 230 can have an average electrolyte salt concentration gradient of about 1.0×10⁷ mol/m⁴, about 1.1×10⁷ mol/m⁴, about 1.2×10⁷ mol/m⁴, about 1.3×10⁷ mol/m⁴, about 1.4×10⁷ mol/m⁴, about 1.5×10⁷ mol/m⁴, about 1.6×10⁷ mol/m⁴, about 1.7×10⁷ mol/m⁴, about 1.8×10⁷ mol/m⁴, about 1.9×10⁷ mol/m⁴, about 2.0×10⁷ mol/m⁴, about 2.1×10⁷ mol/m⁴, about 2.2×10⁷ mol/m⁴, about 2.3×10⁷ mol/m⁴, about 2.4×10⁷ mol/m⁴, about 2.5×10⁷ mol/m⁴, about 2.6×10⁷ mol/m⁴, about 2.7×10⁷ mol/m⁴, about 2.8×10⁷ mol/m⁴, about 2.9×10⁷ mol/m⁴, about 3.0×10⁷ mol/m⁴, about 3.1×10⁷ mol/m⁴, about 3.2×10⁷ mol/m⁴, about 3.3×10⁷ mol/m⁴, about 3.4×10⁷ mol/m⁴, about 3.5×10⁷ mol/m⁴, about 3.6×10⁷ mol/m⁴, about 3.7×10⁷ mol/m⁴, about 3.8×10⁷ mol/m⁴, about 3.9×10⁷ mol/m⁴, about 4.0×10⁷ mol/m⁴, about 4.1×10⁷ mol/m⁴, about 4.2×10⁷ mol/m⁴, about 4.3×10⁷ mol/m⁴, about 4.4×10⁷ mol/m⁴, about 4.5×10⁷ mol/m⁴, about 4.6×10⁷ mol/m⁴, about 4.7×10⁷ mol/m⁴, about 4.8×10⁷ mol/m⁴, about 4.9×10⁷ mol/m⁴, or about 5.0×10⁷ mol/m⁴.

In some embodiments, the cathode 230 can have a density gradient. In some embodiments, the density gradient can be present while the electrochemical cell 200 is charging. In some embodiments, the density gradient can be present while the electrochemical cell 200 is discharging. In some embodiments, the density gradient can be present while the electrochemical cell 200 is dormant. In some embodiments, the cathode 230 can have an average density gradient of at least about 1×10⁵ kg/m⁴, at least about 2×10⁵ kg/m⁴, at least about 3×10⁵ kg/m⁴, at least about 4×10⁵ kg/m⁴, at least about 5×10⁵ kg/m⁴, at least about 6×10⁵ kg/m⁴, at least about 7×10⁵ kg/m⁴, at least about 8×10⁵ kg/m⁴, at least about 9×10⁵ kg/m⁴, at least about 1×10⁶ kg/m⁴, at least about 2×10⁶ kg/m⁴, at least about 3×10⁶ kg/m⁴, at least about 4×10⁶ kg/m⁴, at least about 5×10⁶ kg/m⁴, at least about 6×10⁶ kg/m⁴, at least about 7×10⁶ kg/m⁴, at least about 8×10⁶ kg/m⁴, at least about 9×10⁶ kg/m⁴, at least about 1×10⁷ kg/m⁴, at least about 2×10⁷ kg/m⁴, at least about 3×10⁷ kg/m⁴, at least about 4×10⁷ kg/m⁴, at least about 5×10⁷ kg/m⁴, at least about 6×10⁷ kg/m⁴, at least about 7×10⁷ kg/m⁴, at least about 8×10⁷ kg/m⁴, at least about 9×10⁷ kg/m⁴, at least about 1×10⁸ kg/m⁴, at least about 2×10⁸ kg/m⁴, at least about 3×10⁸ kg/m⁴, at least about 4×10′ kg/m⁴, at least about 5×10⁸ kg/m⁴, at least about 6×10⁸ kg/m⁴, at least about 7×10⁸ kg/m⁴, at least about 8×10⁸ kg/m⁴, or at least about 9×10′ kg/m⁴. In some embodiments, the cathode 230 can have an average density gradient of no more than about 1×10⁹ kg/m⁴, no more than about 9×10′ kg/m⁴, no more than about 8×10⁸ kg/m⁴, no more than about 7×10′ kg/m⁴, no more than about 6×10⁸ kg/m⁴, no more than about 5×10⁸ kg/m⁴, no more than about 4×10′ kg/m⁴, no more than about 3×10⁸ kg/m⁴, no more than about 2×10⁸ kg/m⁴, no more than about 1×10⁸ kg/m⁴, no more than about 9×10⁷ kg/m⁴, no more than about 8×10⁷ kg/m⁴, no more than about 7×10⁷ kg/m⁴, no more than about 6×10⁷ kg/m⁴, no more than about 5×10⁷ kg/m⁴, no more than about 4×10⁷ kg/m⁴, no more than about 3×10⁷ kg/m⁴, no more than about 2×10⁷ kg/m⁴, no more than about 1×10⁷ kg/m⁴, no more than about 9×10⁶ kg/m⁴, no more than about 8×10⁶ kg/m⁴, no more than about 7×10⁶ kg/m⁴, no more than about 6×10⁶ kg/m⁴, no more than about 5×10⁶ kg/m⁴, no more than about 4×10⁶ kg/m⁴, no more than about 3×10⁶ kg/m⁴, no more than about 2×10⁶ kg/m⁴, no more than about 1×10⁶ kg/m⁴, no more than about 9×10⁵ kg/m⁴, no more than about 8×10⁵ kg/m⁴, no more than about 7×10⁵ kg/m⁴, no more than about 6×10⁵ kg/m⁴, no more than about 5×10⁵ kg/m⁴, no more than about 4×10⁵ kg/m⁴, no more than about 3×10⁵ kg/m⁴, or no more than about 2×10⁵ kg/m⁴.

Combinations of the above-referenced average density gradients are also possible (e.g., at least about 1×10⁵ kg/m⁴ and no more than about 1×10⁹ kg/m⁴ or at least about 1×10⁶ kg/m⁴ and no more than about 1×10′ kg/m⁴), inclusive of all values and ranges therebetween. In some embodiments, the cathode 230 can have an average density gradient of about 1×10⁵ kg/m⁴, about 2×10⁵ kg/m⁴, about 3×10⁵ kg/m⁴, about 4×10⁵ kg/m⁴, about 5×10⁵ kg/m⁴, about 6×10⁵ kg/m⁴, about 7×10⁵ kg/m⁴, about 8×10⁵ kg/m⁴, about 9×10⁵ kg/m⁴, about 1×10⁶ kg/m⁴, about 2×10⁶ kg/m⁴, about 3×10⁶ kg/m⁴, about 4×10⁶ kg/m⁴, about 5×10⁶ kg/m⁴, about 6×10⁶ kg/m⁴, about 7×10⁶ kg/m⁴, about 8×10⁶ kg/m⁴, about 9×10⁶ kg/m⁴, about 1×10⁷ kg/m⁴, about 2×10⁷ kg/m⁴, about 3×10⁷ kg/m⁴, about 4×10⁷ kg/m⁴, about 5×10⁷ kg/m⁴, about 6×10⁷ kg/m⁴, about 7×10⁷ kg/m⁴, about 8×10⁷ kg/m⁴, about 9×10⁷ kg/m⁴, about 1×10⁸ kg/m⁴, about 2×10′ kg/m⁴, about 3×10⁸ kg/m⁴, about 4×10′ kg/m⁴, about 5×10⁸ kg/m⁴, about 6×10⁸ kg/m⁴, about 7×10⁸ kg/m⁴, about 8×10′ kg/m⁴, about 9×10′ kg/m⁴, or about 1×10⁹ kg/m⁴.

In some embodiments, the cathode 230 can have a viscosity (at 25° C.) of at least about 100 Pa·s, at least about 150 Pa·s, at least about 200 Pa·s, at least about 250 Pa·s, at least about 300 Pa·s, at least about 350 Pa·s, at least about 400 Pa·s, at least about 450 Pa·s, at least about 500 Pa·s, at least about 550 Pa·s, at least about 600 Pa·s, at least about 650 Pa·s, at least about 700 Pa·s, at least about 750 Pa·s, at least about 800 Pa·s, at least about 850 Pa·s, at least about 900 Pa·s, or at least about 950 Pa·s. In some embodiments, the cathode 230 can have a viscosity of no more than about 1,000 Pa·s, no more than about 950 Pa·s, no more than about 900 Pa·s, no more than about 850 Pa·s, no more than about 800 Pa·s, no more than about 750 Pa·s, no more than about 700 Pa·s, no more than about 650 Pa·s, no more than about 600 Pa·s, no more than about 550 Pa·s, no more than about 500 Pa·s, no more than about 450 Pa·s, no more than about 400 Pa·s, no more than about 350 Pa·s, no more than about 300 Pa·s, no more than about 250 Pa·s, no more than about 200 Pa·s, or no more than about 950 Pa·s. Combinations of the above-referenced viscosities are also possible (e.g., at least about 100 Pa·s and no more than about 1,000 Pa·s or at least about 300 Pa·s and no more than about 600 Pa·s), inclusive of all values and ranges therebetween. In some embodiments, the cathode 230 can have a viscosity of about 100 Pa·s, about 150 Pa·s, about 200 Pa·s, about 250 Pa·s, about 300 Pa·s, about 350 Pa·s, about 400 Pa·s, about 450 Pa·s, about 500 Pa·s, about 550 Pa·s, about 600 Pa·s, about 650 Pa·s, about 700 Pa·s, about 750 Pa·s, about 800 Pa·s, about 850 Pa·s, about 900 Pa·s, about 950 Pa·s, or about 1,000 Pa·s.

In some embodiments, the cathode 230 can have a viscosity gradient. In some embodiments, the viscosity gradient can be present while the electrochemical cell 200 is charging. In some embodiments, the viscosity gradient can be present while the electrochemical cell 200 is discharging. In some embodiments, the viscosity gradient can be present while the electrochemical cell 200 is dormant. In some embodiments, the cathode 210 can have an average viscosity gradient of at least about 1×10⁵ Pa·s/m, at least about 2×10⁵ Pa·s/m, at least about 3×10⁵ Pa·s/m, at least about 4×10⁵ Pa·s/m, at least about 5×10⁵ Pa·s/m, at least about 6×10⁵ Pa·s/m, at least about 7×10⁵ Pa·s/m, at least about 8×10⁵ Pa·s/m, at least about 9×10⁵ Pa·s/m, at least about 1×10⁶ Pa·s/m, at least about 2×10⁶ Pa·s/m, at least about 3×10⁶ Pa·s/m, at least about 4×10⁶ Pa·s/m, at least about 5×10⁶ Pa·s/m, at least about 6×10⁶ Pa·s/m, at least about 7×10⁶ Pa·s/m, at least about 8×10⁶ Pa·s/m, at least about 9×10⁶ Pa·s/m, at least about 1×10⁷ Pa·s/m, at least about 2×10⁷ Pa·s/m, at least about 3×10⁷ Pa·s/m, at least about 4×10⁷ Pa·s/m, at least about 5×10⁷ Pa·s/m, at least about 6×10⁷ Pa·s/m, at least about 7×10⁷ Pa·s/m, at least about 8×10⁷ Pa·s/m, at least about 9×10⁷ Pa·s/m, at least about 1×10⁸ Pa·s/m, at least about 2×10⁸ Pa·s/m, at least about 3×10⁸ Pa·s/m, at least about 4×10′ Pa·s/m, at least about 5×10⁸ Pa·s/m, at least about 6×10⁸ Pa·s/m, at least about 7×10⁸ Pa·s/m, at least about 8×10⁸ Pa·s/m, or at least about 9×10⁸ Pa·s/m. In some embodiments, the cathode 210 can have an average viscosity gradient of no more than about 1×10⁹ Pa·s/m, no more than about 9×10⁸ Pa·s/m, no more than about 8×10⁸ Pa·s/m, no more than about 7×10⁸ Pa·s/m, no more than about 6×10⁸ Pa·s/m, no more than about 5×10⁸ Pa·s/m, no more than about 4×10⁸ Pa·s/m, no more than about 3×10⁸ Pa·s/m, no more than about 2×10⁸ Pa·s/m, no more than about 1×10⁸ Pa·s/m, no more than about 9×10⁷ Pa·s/m, no more than about 8×10⁷ Pa·s/m, no more than about 7×10⁷ Pa·s/m, no more than about 6×10⁷ Pa·s/m, no more than about 5×10⁷ Pa·s/m, no more than about 4×10⁷ Pa·s/m, no more than about 3×10⁷ Pa·s/m, no more than about 2×10⁷ Pa·s/m, no more than about 1×10⁷ Pa·s/m, no more than about 9×10⁶ Pa·s/m, no more than about 8×10⁶ Pa·s/m, no more than about 7×10⁶ Pa·s/m, no more than about 6×10⁶ Pa·s/m, no more than about 5×10⁶ Pa·s/m, no more than about 4×10⁶ Pa·s/m, no more than about 3×10⁶ Pa·s/m, no more than about 2×10⁶ Pa·s/m, no more than about 1×10⁶ Pa·s/m, no more than about 9×10⁵ Pa·s/m, no more than about 8×10⁵ Pa·s/m, no more than about 7×10⁵ Pa·s/m, no more than about 6×10⁵ Pa·s/m, no more than about 5×10⁵ Pa·s/m, no more than about 4×10⁵ Pa·s/m, no more than about 3×10⁵ Pa·s/m, or no more than about 2×10⁵ Pa·s/m.

Combinations of the above-referenced average viscosity gradients are also possible (e.g., at least about 1×10⁵ Pa·s/m and no more than about 1×10⁹ Pa·s/m or at least about 1×10⁶ Pa·s/m and no more than about 1×10⁸ Pa·s/m), inclusive of all values and ranges therebetween. In some embodiments, the cathode 230 can have an average viscosity gradient of about 1×10⁵ Pa·s/m, about 2×10⁵ Pa·s/m, about 3×10⁵ Pa·s/m, about 4×10⁵ Pa·s/m, about 5×10⁵ Pa·s/m, about 6×10⁵ Pa·s/m, about 7×10⁵ Pa·s/m, about 8×10⁵ Pa·s/m, about 9×10⁵ Pa·s/m, about 1×10⁶ Pa·s/m, about 2×10⁶ Pa·s/m, about 3×10⁶ Pa·s/m, about 4×10⁶ Pa·s/m, about 5×10⁶ Pa·s/m, about 6×10⁶ Pa·s/m, about 7×10⁶ Pa·s/m, about 8×10⁶ Pa·s/m, about 9×10⁶ Pa·s/m, about 1×10⁷ Pa·s/m, about 2×10⁷ Pa·s/m, about 3×10⁷ Pa·s/m, about 4×10⁷ Pa·s/m, about 5×10⁷ Pa·s/m, about 6×10⁷ Pa·s/m, about 7×10⁷ Pa·s/m, about 8×10⁷ Pa·s/m, about 9×10⁷ Pa·s/m, about 1×10⁸ Pa·s/m, about 2×10⁸ Pa·s/m, about 3×10⁸ Pa·s/m, about 4×10⁸ Pa·s/m, about 5×10⁸ Pa·s/m, about 6×10⁸ Pa·s/m, about 7×10⁸ Pa·s/m, about 8×10⁸ Pa·s/m, about 9×10⁸ Pa·s/m, or about 1×10⁹ Pa·s/m.

In some embodiments, the cathode current collector 240 can include aluminum or any other suitable current collector material. In some embodiments, the cathode current collector 240 can have a thickness of at least about 1 μm, at least about 2 μm, at least about 3 μm, at least about 4 μm, at least about 5 μm, at least about 10 μm, at least about 15 μm, at least about 20 μm, at least about 25 μm, at least about 30 μm, at least about 35 μm, at least about 40 μm, or at least about 45 μm. In some embodiments, the cathode current collector 240 can have a thickness of no more than about 50 μm, no more than about 45 μm, no more than about 40 μm, no more than about 35 μm, no more than about 30 μm, no more than about 25 μm, no more than about 20 μm, no more than about 15 μm, no more than about 10 μm, no more than about 5 μm, no more than about 4 μm, no more than about 3 μm, or no more than about 2 μm. Combinations of the above-referenced thicknesses of the cathode current collector 240 are also possible (e.g., at least about 1 μm and no more than about 50 μm or at least about 5 μm and no more than about 20 μm), inclusive of all values and ranges therebetween. In some embodiments, the cathode current collector 240 can have a thickness of about 1 μm, about 2 μm, about 3 μm, about 4 μm, about 5 μm, about 10 μm, about 15 μm, about 20 μm, about 25 μm, about 30 μm, about 35 μm, about 40 μm, about 45 μm, or about 50 μm.

The separator 250 can include any suitable separator that acts as an ion-permeable membrane. In other words, the separator 250 allows exchange of ions while maintaining physical separation of the cathode 230 and the anode 210. For example, the separator 250 can be any conventional membrane that is capable of ion transport. In some embodiments, the separator 250 is a liquid impermeable membrane that permits the transport of ions therethrough, namely a solid or gel ionic conductor. In some embodiments the separator 250 is a porous polymer membrane infused with a liquid electrolyte that allows for the shuttling of ions between the cathode 230 and anode 210 electroactive materials, while preventing the transfer of electrons. In some embodiments, the separator 250 can be a microporous membrane that prevents particles forming the positive and negative electrode compositions from crossing the membrane. For example, the membrane materials can be selected from polyethyleneoxide (PEO) polymer in which a lithium salt is complexed to provide lithium conductivity, or Nation™ membranes which are proton conductors. For example, PEO based electrolytes can be used as the membrane, which is pinhole-free and a solid ionic conductor, optionally stabilized with other membranes such as glass fiber separators as supporting layers. PEO can also be used as a slurry stabilizer, dispersant, etc. in the positive or negative redox compositions. PEO is stable in contact with typical alkyl carbonate-based electrolytes. This can be especially useful in phosphate-based cell chemistries with cell potential at the positive electrode that is less than about 3.6 V with respect to Li metal. The operating temperature of the redox cell can be elevated as necessary to improve the ionic conductivity of the membrane. In some embodiments, the separator 250 can include polyethylene, polypropylene, polyimide, or any combination thereof.

In some embodiments, the separator 250 can have a thickness of at least about 5 μm, at least about 10 μm, at least about 15 μm, at least about 20 μm, at least about 25 μm, at least about 30 μm, at least about 35 μm, at least about 40 μm, or at least about 45 μm. In some embodiments, the separator 250 can have a thickness of no more than about 50 μm, no more than about 45 μm, no more than about 40 μm, no more than about 35 μm, no more than about 30 μm, no more than about 25 μm, no more than about 20 μm, no more than about 15 μm, or no more than about 10 μm. Combinations of the above-referenced thicknesses are also possible (e.g., at least about 5 μm and no more than about 50 μm or at least about 10 μm and no more than about 30 μm), inclusive of all values and ranges therebetween. In some embodiments, the separator 250 can have a thickness of about 5 μm, about 10 μm, about 15 μm, about 20 μm, about 25 μm, about 30 μm, about 35 μm, about 40 μm, about 45 μm, or about 50 μm.

In some embodiments, the carbon coating 260 can include any of the materials listed above with respect to carbon coating applied at step 15. In some embodiments, the carbon coating 260 can be mixed with electrolyte solution. In some embodiments, the carbon coating 260 can be mixed with the same electrolyte solution as the anode 230. In some embodiments, the carbon coating 260 can have a thickness of at least about 500 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, or at least about 19 μm. In some embodiments, the carbon coating 260 can have a thickness of no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, or no more than about 1 μm. Combinations of the above-referenced thicknesses of the carbon coating 260 are also possible (e.g., at least about 500 nm and no more than about 20 μm or at least about 5 μm and no more than about 15 μm), inclusive of all values and ranges therebetween. In some embodiments, the carbon coating 260 can have a thickness of about 500 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm.

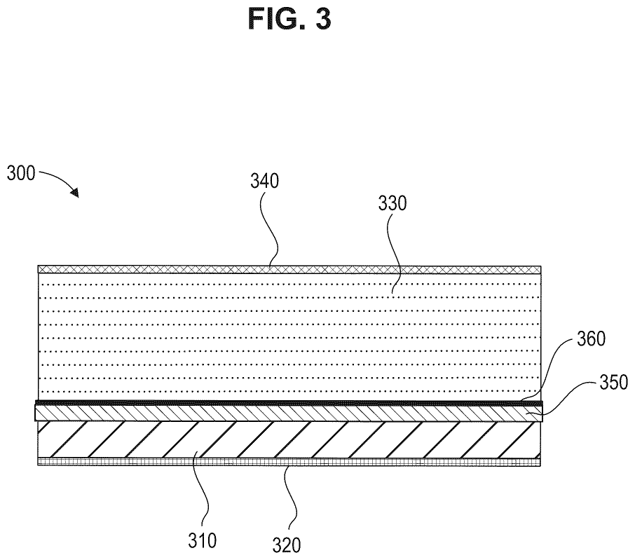

FIG. 3 is an illustration of an electrochemical cell 300, according to an embodiment. As shown, the electrochemical cell 300 includes an anode 310 disposed on an anode current collector 320, a cathode 330 disposed on a cathode current collector 340, with a separator 350 disposed between the anode 310 and the cathode 330 and a carbon coating 360 disposed between the cathode 330 and the separator 350. In some embodiments, the anode 310, the anode current collector 320, the cathode 330, the cathode current collector 340, the separator 350, and the carbon coating 360 can be the same or substantially similar to the anode 210, the anode current collector 220, the cathode 230, the cathode current collector 240, the separator 250, and the carbon coating 260, as described above with reference to FIG. 2. Thus, certain aspects of the anode 310, the anode current collector 320, the cathode 330, the cathode current collector 340, the separator 350, and the carbon coating 360 are not described in greater detail herein.

In some embodiments, the cathode 330 can have a thickness larger than a thickness of the anode 310. In some embodiments, a ratio of the thickness of the cathode 330 to the thickness of the anode 310 can be at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, at least about 5, at least about 5.5, at least about 6, at least about 6.5, at least about 7, at least about 7.5, at least about 8, at least about 8.5, at least about 9, or at least about 9.5. In some embodiments, the ratio of the thickness of the cathode 330 to the thickness of the anode 310 can be no more than about 10, no more than about 9.5, no more than about 9, no more than about 8.5, no more than about 8, no more than about 7.5, no more than about 7, no more than about 6.5, no more than about 6, no more than about 5.5, no more than about 5, no more than about 4.5, no more than about 4, no more than about 3.5, no more than about 3, no more than about 2.5, no more than about 2, no more than about 1.9, no more than about 1.8, no more than about 1.7, no more than about 1.6, no more than about 1.5, no more than about 1.4, no more than about 1.3, or no more than about 1.2. Combinations of the above-referenced thickness ratios are also possible (e.g., at least about 1.1 and no more than about 10 or at least about 3 and no more than about 8), inclusive of all values and ranges therebetween. In some embodiments, a ratio of the thickness of the cathode 330 to the thickness of the anode 310 can be about 1.1, about 1.2, about 1.3, about 1.4, about 1.5, about 1.6, about 1.7, about 1.8, about 1.9, about 2, about 2.5, about 3, about 3.5, about 4, about 4.5, about 5, about 5.5, about 6, about 6.5, about 7, about 7.5, about 8, about 8.5, about 9, about 9.5, or about 10.

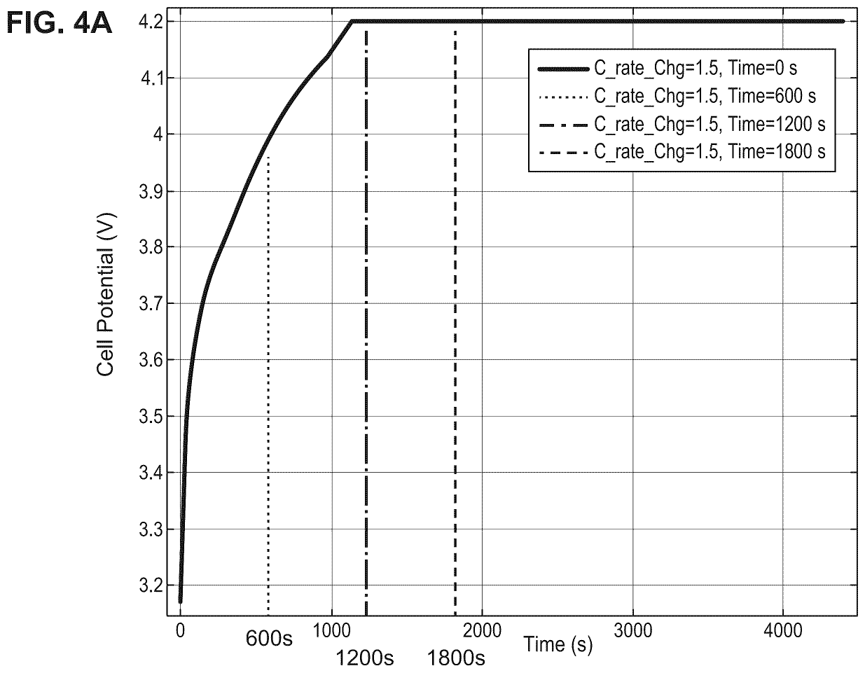

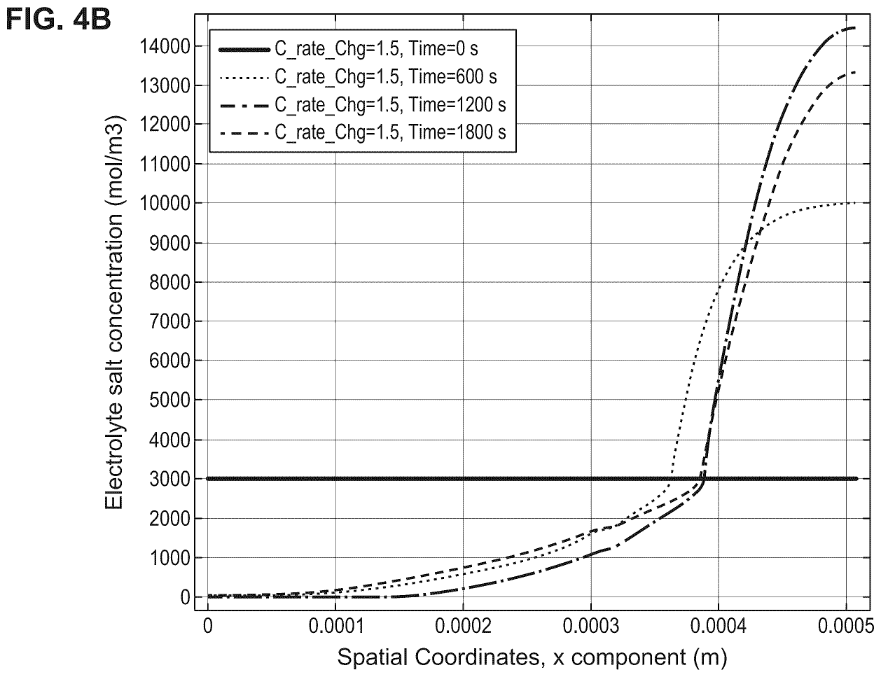

FIGS. 4A-4B show simulated plots of performance of electrochemical cells. FIG. 4A shows cell potential at various charging times while charging at 1.5 C. A≥1 C fast charge was simulated using COMSOL Multiphysics with a 3.0 M electrolyte, cathodes with a thickness of 190 μm, anodes with a thickness of 300 μm, and separators with a thickness of 12 μm. FIG. 4B shows salt concentration profiles in the anode, separator, and cathode during 1.5 C charge at different times of charging. As shown, the spatial coordinates of 0.0005 m correspond to the interface between the cathode and the current collector, and the spatial coordinates of 0 m correspond to the interface between the anode and the current collector. As shown, the salt concentration is uniform throughout the electrode to start and becomes unevenly distributed throughout the charging of the electrochemical cell. As shown, at around 600 s, the electrolyte salt concentration has an average gradient of about 2×10¹ mol/m⁴ at t=600 s, about 2.9×10⁸ mol/m⁴ at t=1200 s, and about 2.6×10⁸ mol/m⁴ at t=1800 s.

### Examples

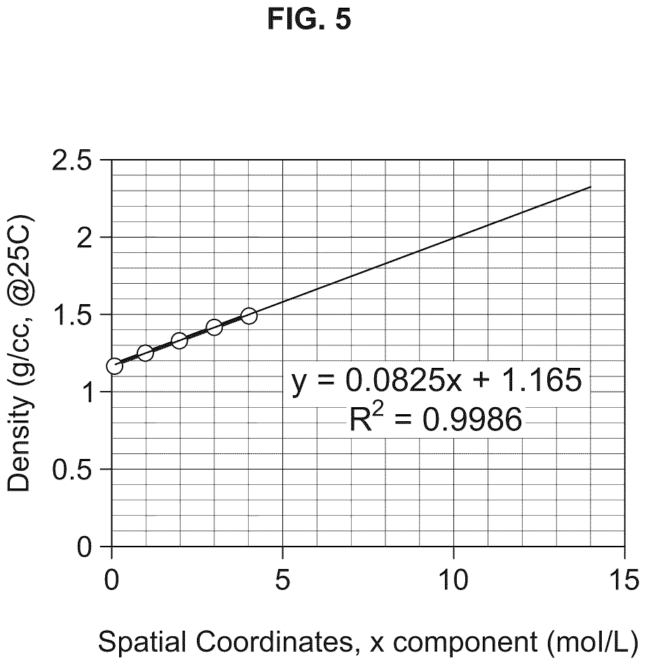

FIG. 5 shows density of an electrolyte with LiFSI salt in a solvent with 3:7 (w:w) EC/DMC with 2 wt % VC. The x-axis shows the molar concentration of LiFSI salt in the solution. As shown, there is a strong linear correlation between salt concentration and density. Higher salt concentrations give way to higher densities.

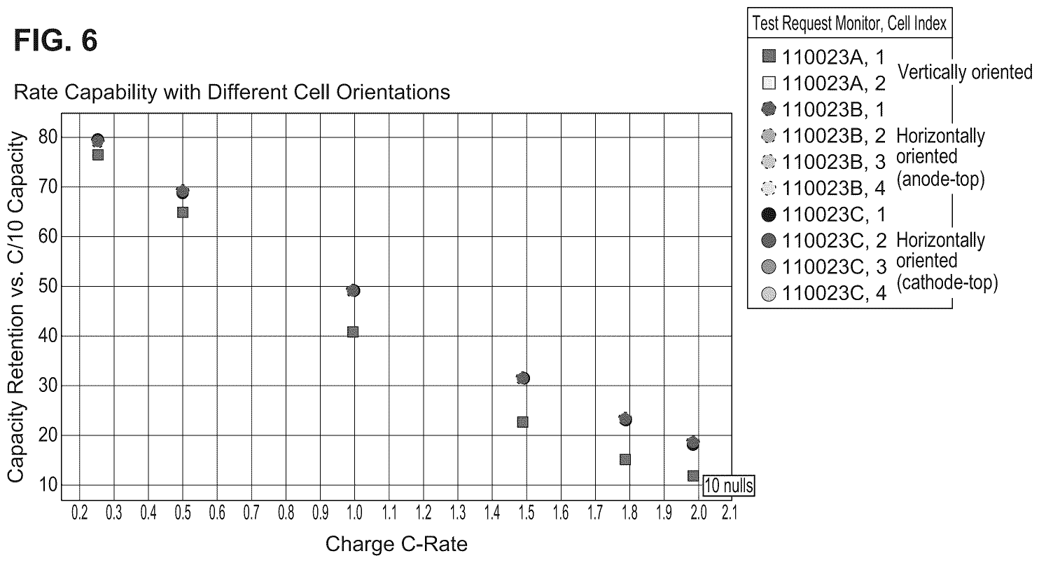

FIG. 6 shows rate capability with different cell orientations. To take advantage of density gradients in a cell, the effect of gravity on rate capabilities was investigated. In other words, the orientations of electrochemical cells were varied and the differences in rate capabilities were investigated. The data indicated with blue dots correspond to cells that are vertically oriented, with the length dimensions of the electrodes aligned with gravity. The data indicated with orange dots correspond to cells that are horizontally oriented, with the thickness dimensions of the electrodes aligned with gravity, and with the anode on top. The data indicated with green dots correspond to cells that are horizontally oriented, and with the cathode on top. As shown, the horizontally oriented cells have better rate capabilities than the vertically oriented cells. The cells with the anode on top are virtually indistinguishable from the cells with the cathode on top.

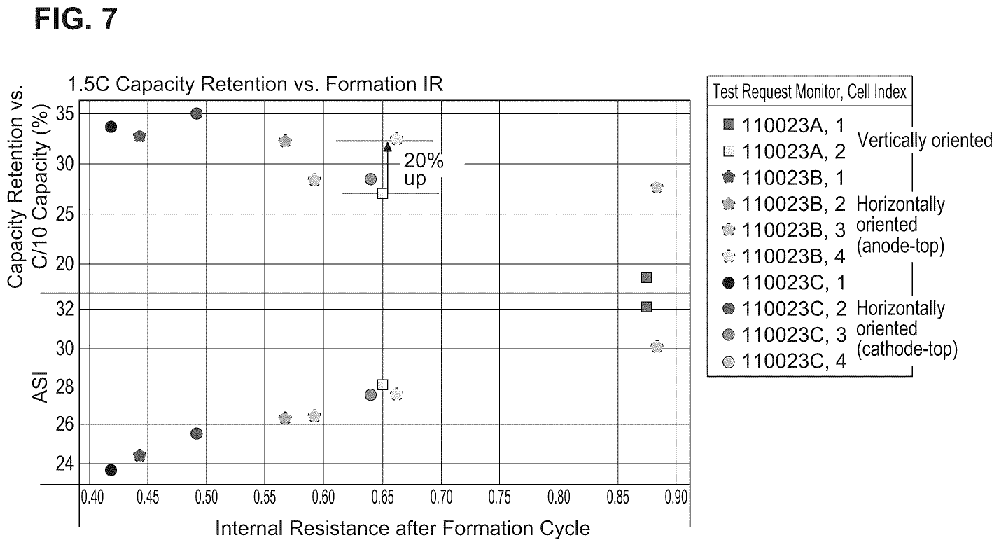

To evaluate the cause of the superior rate capabilities of the horizontally oriented cells, the capacity retention of 1.5 C charge relative to the capacity of C/10 charge and areal specific impedance (ASI) were compared against internal resistance (IR). FIG. 7 shows a general negative correlation between 1.5 C capacity retention vs. IR and a positive correlation between 1.5 C capacity retention and ASI. However, horizontally oriented cells showed higher capacity retention than vertically oriented cells by about 20% at similar IR values. This implies an importance of cell orientation for fast charge capabilities. The influence is not seen at a stationary state before the cycle, but appears during the charge, when the concentration gradient is present in the electrolyte. Convection induced by gravity and density differences of electrolyte throughout the cell may at least partially enable better fast charge capabilities of the cell when the concentration gradient and gravity are aligned in the same direction.

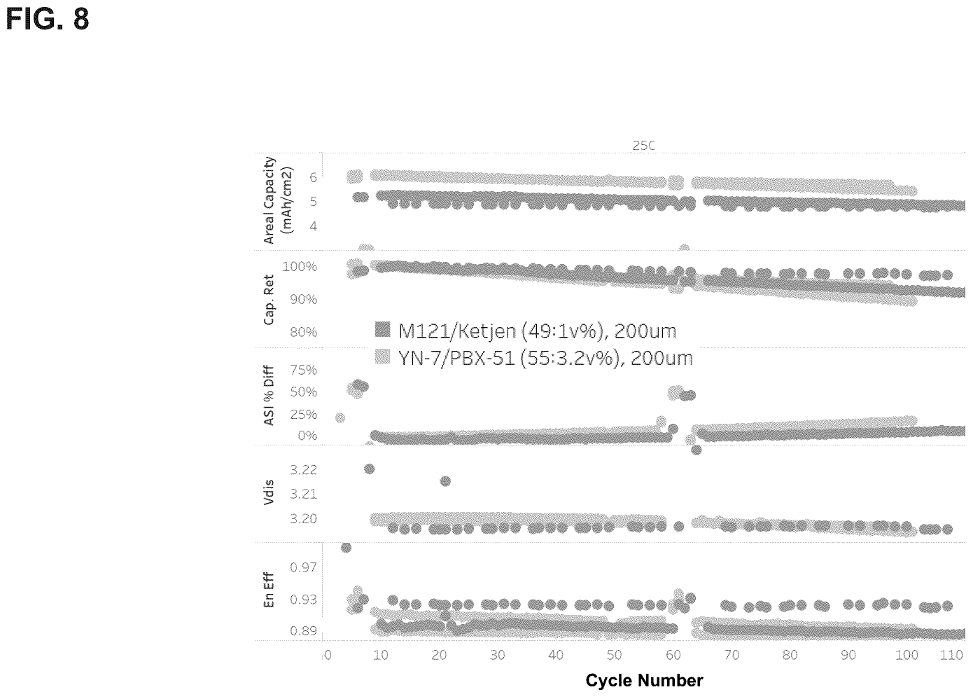

FIG. 8 demonstrates fast charge capability of electrochemical cells with a 2 M single salt. An electrolyte was formed from 2M LiFSI in EC/PC/EMC (2:1:7 wt %)+0.5 wt % VC+1.5 wt % DTD+2 wt % TTE. The electrolyte was integrated into cells with 49 vol % LFP and 55 vol % LFP. The 49 vol % LFP cell included Ketjen carbon, while the 55 vol % LFP cell included PBX-51. Both cells included LFP cathodes with thicknesses of 200 μm. Anodes included HDL11 anodes. The cells were discharged at ≥1 C to 0.8 SOC and charged at C/4 to 1.0 SOC. The separators were polyethylene separators. As shown, both cells maintained over 90% of their original capacity through 100 cycles.

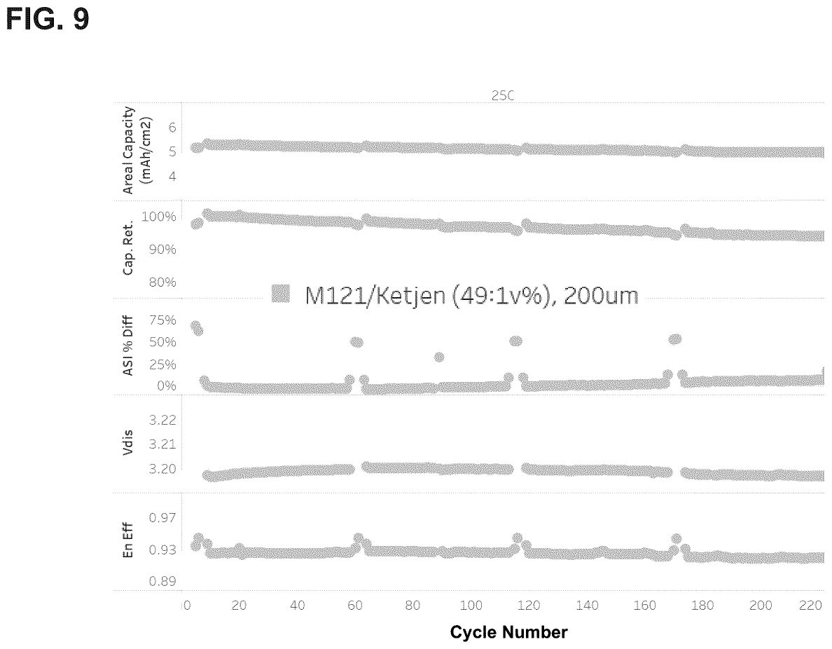

FIG. 9 demonstrates fast charge capability of electrochemical cells with a 2 M dual salt. An electrolyte was formed from 1.5M LiPF₆ and 0.5 M LiFSI in EC/PC/EMC (2:1:7 wt %)+0.5 wt % VC+1.5 wt % DTD+2 wt % TTE. The cells were discharged at ≥1 C to 0.8 SOC and charged at C/4 to 1.0 SOC. The electrolyte was integrated into cells with 49 vol % with Ketjen. The cell included an HDL 11 anode and a polyethylene separator. As shown, the cell maintained over 90% of its original capacity through 220 cycles.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/of” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell, comprising:
a cathode current collector;
a semi-solid cathode disposed on the cathode current collector, the semi-solid cathode having a thickness of at least about 150 μm and including an active material, a conductive material, and an electrolyte, the electrolyte including a non-aqueous solvent and an electrolyte salt;
an anode current collector;
an anode disposed on the anode current collector; and
a separator disposed between the anode and the cathode,
wherein the electrolyte salt has an average concentration gradient in the semi-solid cathode of at least about 2×10⁷ mol/m⁴.

2. The electrochemical cell of claim 1, wherein the electrolyte salt has an average concentration in the non-aqueous liquid electrolyte of at least about 2,000 mol/m³.

3. The electrochemical cell of claim 2, wherein the electrolyte salt has an average concentration in the non-aqueous liquid electrolyte of at least about 3,000 mol/m³.

4. The electrochemical cell of claim 1, wherein the electrolyte salt has an average concentration gradient in the semi-solid cathode of at least about 3×10⁷ mol/m⁴.

5. The electrochemical cell of claim 1, wherein the electrolyte salt includes at least one of lithium bis(oxalato)borate (LiBOB), lithium hexafluorophosphate (LiPF₆), or lithium bis(fluorosulfony)imide (LiFSI).

6. The electrochemical cell of claim 1, wherein the separator is coated with the non-aqueous liquid electrolyte.

7. The electrochemical cell of claim 6, wherein the separator is coated with hard carbon.

8. A method comprising:
combining an active material with a conductive material and a non-aqueous liquid electrolyte to form a semi-solid cathode, the non-aqueous liquid electrolyte having a salt concentration of at least about 2,000 mol/m³;
disposing the semi-solid cathode onto a cathode current collector, the semi-solid cathode having a thickness of at least about 150 μm;
disposing an anode onto an anode current collector;
wetting a first surface of the separator with the non-aqueous liquid electrolyte;
coating the first surface of the separator with a carbon coating; and
disposing the anode onto the cathode with the separator interposed therebetween to form an electrochemical cell, such that the first surface of the separator contacts the semi-solid cathode.

9. The method of claim 8, further comprising:
charging and discharging the electrochemical cell while the electrochemical cell is oriented such that the thickness of the cathode is in line with the direction of gravity.

10. The method of claim 8, wherein the non-aqueous liquid electrolyte has a salt concentration of at least about 3,000 mol/m³.

11. The method of claim 8, wherein the carbon coating includes hard carbon.

12. The method of claim 9, wherein the charging and the discharging are at a rate of at least about 1.5 C.

13. The method of claim 8, further comprising:
charging and discharging the electrochemical cell while applying at least one of a magnetic field, a heating, or a centrifugal force to the electrochemical cell.

14. The method of claim 8, wherein the first non-aqueous liquid electrolyte includes at least one of vinylene carbonate (VC), 1,3 propane sultone (PS), ethyl propionate (EP), 1,3-propanediol cyclic sulfate (PSA/TS), fluoroethylene carbonate (FEC), ethylene sulfite (ES), tris(2-ethylhexyl) phosphate (TOP), ethylene sulfate (DTD), ethyl acetate (EA), maleic anhydride (MA), ethylene carbonate (EC), propylene carbonate (PC), dimethyl carbonate (DMC), or ethyl methyl carbonate (EMC).

15. An electrochemical cell, comprising:
a first current collector;
a first electrode material disposed on the first current collector and having a semi-solid composition, the first electrode material having a thickness of at least about 150 μm and including an active material, a conductive material, an electrolyte salt, and an electrolyte solvent, the electrolyte salt having a concentration gradient along the thickness of the first electrode material of at least about 2×10⁷ mol/m⁴;
a second current collector;
a second electrode material disposed on the second current collector;
a separator disposed between the first electrode material and the second electrode material; and
a carbon coating disposed between the first electrode material and the separator.

16. The electrochemical cell of claim 15, wherein the carbon coating includes at least one of hard carbon, disordered carbon, graphite, graphitic or non-graphitic carbon, amorphous carbon, mesocarbon, microbeads, soft carbon, activated carbon, or a graphitic hard carbon mixture.

17. The electrochemical cell of claim 15, wherein the electrolyte solvent is a non-aqueous solvent.

18. The electrochemical cell of claim 15, wherein the electrolyte salt has a concentration gradient along the thickness of the first electrode material of at least about 3×10⁷ mol/m⁴.

19. The electrochemical cell of claim 15, wherein the electrolyte salt includes at least one of lithium bis(oxalato)borate (LiBOB), lithium hexafluorophosphate (LiPF₆), or lithium bis(fluorosulfony)imide (LiFSI).

20. The electrochemical cell of claim 15, wherein the first electrode has a viscosity gradient of at least about 5×10⁵ Pa·s/m.
